(19) United States
(12) Patent Application Publication
(10) Pub. No.: US 2012/0267472 A1
(43) Pub. Date: Oct. 25, 2012

(54) AIR VEHICLE

(75) Inventors: Arie Pratzovnick, Ramat Gan (IL); Shmuel Ron, Nes-Ziyyona (IL)

(73) Assignee: ELTA SYSTEMS LTD., Ashdod (IL)

(21) Appl. No.: 13/376,446

(22) PCT Filed: Jun. 2, 2010
(86) PCT No.: PCT/IL10/00435

§ 371 Date: Jul. 2, 2012

(30) Foreign Application Priority Data
Jun. 8, 2009 (IL) 199230

(51) Int. Cl. H01Q 1/28; G06F 17/50; B64C 39/02; G01S 1/04; B64C 3/00; B64C 1/00

(52) U.S. Cl. 244/13; 244/119; 342/385; 703/1

(57) ABSTRACT

A sensor/emitter arrangement (M1-M3) is integrated into the fuselage (120) structure of a specially designed air vehicle (100), in which the air vehicle is configured for optimizing operation of the sensor/emitter arrangement (M1-M3) with respect to at least azimuthal lines of sight radiating along a azimuthal reference plane of the air vehicle (100). The azimuthal reference plane intersects the air vehicle fuselage (120). In at least some embodiments, the fuselage (120) is formed with a plurality of oblate cross-sections that facilitate maximizing the room available for a sensor/emitter array (172, 174, 176) that is elongated along an elongate axis that may be aligned with the azimuthal reference plane. In at least some embodiments one or more such elongate axes may be inclines to the longitudinal (roll) axis and the pitch axis of the air vehicle (100). In at least some embodiments, the air vehicle may have a blunt aft end incorporating an elongate aft-facing sensor/emitter array (172, 174, 176).

### FIELD OF THE INVENTION

This invention relates to air vehicles, in particular to aircraft configurations and airborne platforms, specially such aircraft configurations and airborne platforms that carry sensor/emitter arrangements.

### BACKGROUND OF THE INVENTION

There exists a great variety of aircraft configurations, each suited to one or more different roles or uses.

Aircraft configurations for fixed wing aircraft can be roughly divided into five general classes: (a) the common configuration of a tubular fuselage body with wings and having an aft tail section for lateral stability and control, with elevators or canards for pitch control (referred to herein as “conventional aircraft configurations”); (b) tailless configurations having no central fuselage, or alternatively having a relatively small central body (commonly referred to as flying wings), for example the Northrop YB-49; (c) tailless configurations having a central body that is blended with the wings (commonly referred to as blended wing body (BWB) aircraft), for example the NASA X-48B project; (d) lifting body configurations, in which the fuselage is shaped to provide aerodynamic lift, for example the Northrop M2-F2 aircraft; (e) other aircraft configurations.

By way of general background, the following publications disclose a variety of fixed-wing aircraft configurations: U.S. Pat. No. 3,854,679, U.S. Pat. No. 4,167,258, U.S. Pat. No. 5,893,535, U.S. Pat. No. 5,899,410, U.S. Pat. No. 6,098,922, U.S. Pat. No. 6,659,394, U.S. Pat. No. 6,708,924, US 2007/0023571, US 2008/0121756.

Some types of existing conventional aircraft are retrofitted for carrying sensors such as radar systems. In particular, Airborne Early Warning (AEW) aircraft (which term is used herein also to include systems such as AWACS, ERIEYE, CONDOR, WEDGETAIL etc.) are often configured to generate radar-based data, identifying potential threats and providing range, altitude and velocity vector data of radar contacts, with an expanded horizon due to the aircraft's altitude.

The design approach for past and current AEW aircraft is based on modifying a tried-and-tested existing aircraft to incorporate a radar system. In many such AEW aircraft designs, radar antennas are housed in a rotating dome or a non-rotating housing mounted to the upper part of the fuselage, for example as disclosed in U.S. Pat. No. 5,049,891, U.S. Pat. No. 4,380,012 or 5,986,611. Such a dome or housing is not part of the fuselage, which was originally conceived and designed for operating in the absence of such a dome or housing.

In other AEW aircraft designs, the nose is modified to incorporate forward facing radar apparatus, often in a bulbous housing. The aft fuselage or tail-cone may be similarly modified and comprises an aft-facing radar apparatus, often housed in an aft bulbous housing, and/or side-facing radar apparatus is essentially “bolted on” to the port and starboard sides of the fuselage. Examples include U.S. Pat. No. 3,833,904, U.S. Pat. No. 3,858,206, U.S. Pat. No. 3,858,208, US 2008/0191927, the BAE Nimrod aircraft and the Phalcon system.

In other AEW aircraft designs, a side-facing radar arrangement is mounted on the upper side of a conventional aircraft fuselage via struts. In another AEW aircraft design, a side facing radar is mounted inside the fuselage facing a radar-transparent portion of the fuselage, for example as disclosed in U.S. Pat. No. 5,097,267.

Some AEW aircraft designs include a radar arrangement fixedly mounted on the underside of the fuselage, but separate from the original fuselage, for example the TBF Avenger aircraft with the AN-APS 20 radar (1944). In another AEW aircraft design, a rotatable radar antenna is retractable into a stored position within the fuselage, and in operation is positioned in a location beneath the fuselage, for example as disclosed in U.S. Pat. No. 3,656,164.

A Boeing UAV concept, referred to by USAF Research Laboratory as the “Sensor Craft” concept, comprises a fuselage with forward and aft fixed joined wings, incorporating electronically steered antenna arrays in the leading edge of the forward wings and the trailing edge of the aft wings.

### SUMMARY OF THE INVENTION

According to a first aspect of the invention, there is provided an air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
a sensor/emitter arrangement configured for at least one of sensing and emitting energy in directions associated with a plurality of different lines of sight (LOS) with respect to said fuselage;
wherein said sensor/emitter arrangement comprises at least one sensor/emitter array, and preferably a plurality of said sensor/emitter arrays, the or each said sensor/emitter array comprising a sensing/emitting face (configured for said at least one of sensing and emitting energy and) that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along (i.e., parallel to) said pitch axis; and
wherein said fuselage is configured for integrating said sensor/emitter arrangement therein for enabling optimizing operation of said sensor/emitter arrangement (i.e., the fuselage integrates said sensor/emitter arrangement therein in a manner that enables optimizing operation of said sensor/emitter arrangement).

According to at least this aspect of the invention, the fuselage itself integrates therein the sensor/emitter arrangement, and the fuselage does not require an additional housing structure (e.g., a radome structure), separate and distinct from the fuselage, in which to house the sensor emitter arrangement. Thus, in at least some embodiments of the invention, the fuselage of the air vehicle according to at least this aspect of the invention, has an absence of a housing structure that is configured for accommodating therein the said sensor/emitter arrangement, wherein such a housing structure is separate and distinct from the fuselage. In particular in at least some embodiments of the invention, the fuselage of the air vehicle according to at least this aspect of the invention, has an absence of a closed housing structure that defines an internal volume, separate and distinct from the internal volume defined by the fuselage, that is configured for accommodating therein the said sensor/emitter arrangement wherein such a housing structure is separate and distinct from the fuselage. It is to be noted that while in some alternative variations of these embodiments, the air vehicle may optionally additionally comprise such a housing structure, for example above and/or below the fuselage, accommodating therein additional sensors and/or emitters, these are different from the sensing/emitter arrangement that is accommodated in the fuselage.

The air vehicle according to this aspect of the invention may comprise one or more of the following features in any desired combination or permutation, though according to this aspect of the invention the air vehicle is not limited to just these features:
(A) at least a part of said fuselage is formed having a generally oblate cross-section perpendicular to said longitudinal axis for accommodating therein at least a portion of said sensor/emitter arrangement.
(B) said fuselage comprises an inverse oblateness ratio, taken as a ratio of said fuselage width to said fuselage height, greater than unity, for example the inverse oblateness ratio may be greater than about 1.5, or greater than 2, or greater than 3, or greater than 4, or greater than 5, or greater than 6, or greater than 7, or greater than 8, or greater than 9, or greater than 10, for example.
(C) said fuselage comprises a first fineness ratio, taken as a ratio of said fuselage length to said fuselage width, of less than about 5.0, or less than about 4, or less than about 3, or less than about 2.0, for example.
(D) said sensor/emitter arrangement comprises a plurality of said sensor/emitter arrays, each sensor/emitter array being configured for operating to provide sensor data and/or to transmit energy for a respective portion of a 360 degree azimuth volume with respect to the air vehicle referenced to said at least one azimuthal reference plane; for example said sensor/emitter arrangement is configured for operating with respect to a substantially continuous 360 degree azimuth volume with respect to the air vehicle referenced to said azimuthal reference plane.
(E) said wing arrangement is different from said fuselage and lacks any portions thereof that intersect with or that is below the azimuthal reference plane of the air vehicle, i.e., looking at the vehicle in the conventional upright position (i.e., non-inverted position) thereof; for example, the respective wing roots are above the azimuthal reference plane of the air vehicle.
(F) each said sensor/emitter array may comprise a sensing/emitting face that is elongated with respect to a respective elongation axis (also referred to herein as elongate axis) and which is configured to sense and/or emit energy for operation of the sensor/emitter arrangement. In at least some embodiments, at least one said sensor emitter array is arranged with the respective sensing/emitting face thereof facing one of the forward and the aft direction along said longitudinal axis. For example, at least one said sensor/emitter array is arranged with the respective elongation axis thereof substantially parallel to said pitch axis of the air vehicle, and located at an aft end of said fuselage.

(G) in some embodiments, said aft end comprises a blunt aft end, i.e., an aerodynamically blunt aft end; while in at least some other embodiments said aft end comprises an aerodynamically streamlined configuration.

(H) in some embodiments at least a majority of said aft end is closed and lacks a streamlined configuration.

(I) in some embodiments said aft end comprises a cross-section that is generally rounded in at least a majority of cross-sections taken perpendicular to the azimuthal reference plane and generally parallel to the longitudinal axis of the air vehicle.

(J) in at least some embodiments, at least one said sensor/emitter array is arranged with the respective elongation axis thereof substantially inclined to said pitch axis and to said longitudinal axis, in plan view (i.e. when viewed in a direction parallel to the yaw axis).
(K) at least one said inclined elongation axis is inclined at an angle between about 10 degrees and about 80 degrees with respect to said longitudinal axis, in plan view.
(L) at least one said inclined elongation axis is inclined at one of an angle of about 30 degrees or an angle of 60 degrees with respect to said longitudinal axis, in plan view.
(M) in some embodiments, the vehicle may comprise three said sensor/emitter arrays, arranged with the respective elongate axes along the sides of an imaginary triangle; for example, the triangle may be an isosceles triangle or an equilateral triangle.
(N) in some embodiments, the air vehicle may comprise four or more said sensor/emitter arrays, arranged with their respective elongate axes in symmetrical disposition with respect to said longitudinal axis.
(O) at least one said elongation axis may be inclined at an angle of about 45 degrees with respect to said longitudinal axis, in plan view.
(P) in at least some embodiments, each sensor/emitter array may have an array height dimension and an array width dimension, taken orthogonal to and along with, respectively, the elongate axis, and an aspect ratio of array width to array height for at least one said array is between about 1.5 and about 10, for example.

(Q) in at least some embodiments, each said sensor/emitter array may be further configured for operating with respect to elevation below said azimuthal reference plane, at least for a respective portion of a 360 degree azimuth volume; for example, said sensor/emitter arrangement is configured for operating with respect to a hemispherical envelope centered on said fuselage and extending radially below said azimuthal reference plane.
(R) in at least some embodiments, each said sensor/emitter array being further configured for operating with respect to elevation above said azimuthal reference plane, at least for a respective portion of said 360 degree azimuth volume; for example, said sensor/emitter arrangement may be configured for operating with respect to elevation above said azimuthal reference plane, for said 360 degree azimuth volume excluding portions thereof associated with said wing arrangement.
(S) in at least some embodiments, said sensor/emitter arrays may be configured for providing substantially similar sensor/emitter performance one to another, at least with respect to one of: sensor/emitter maximum range, sensor/emitter field of view in azimuth, sensor/emitter field of view in elevation with respect to said azimuthal reference plane.
(T) in at least some embodiments, said sensor/emitter arrangement may comprise a radar arrangement, and each said sensor/emitter array may comprise a respective radar array for at least detecting a target; for example, said radar arrays may comprise phase radar arrays. For example, the target may be illuminated by said sensor/emitter arrangement, or by other means independent of said air vehicle, for example.
(U) the air vehicle may comprise a suitable propulsion system, for example dorsally mounted on said fuselage; alternatively, the propulsion system may be mounted at a different position, while minimally interfering or avoiding interference with the said LOS of the sensor/emitter arrangement; alternatively, the air vehicle may lack a propulsion system and may be configured to operate as a glider.
(V) the air vehicle may be configured as a UAV or as a manned air vehicle.
(W) in some embodiments, the air vehicle may be configured as having at least one of an empty weight in excess of about 10,000 lb or of about 6,500 Kg, and a minimum speed in excess of about Mach 0.15.
(X) in some embodiments, the air vehicle may be configured as a subsonic or a transonic air vehicle.
(Y) in at least some embodiments, each said sensor/emitter array is comprised in a respective compartment in said fuselage and facing a fairing that forms part of the outer skin of the air vehicle.
(Z) in at least some embodiments, at least one said sensor/emitter array is a radar array, and the respective fairing thereof is made from a material that is substantially transparent to the radar beams transmitted from and/or received by the respective radar array.
(AA) in at least some embodiments, said fairings each comprise a smooth rounded shape.
(BB) in at least some other embodiments, said fuselage has an outer surface that is faceted, and each said sensor/emitter array comprises a respective said fairing that is substantially flat and spaced from the respective sensor/emitter array, and which forms part of an external skin of said air vehicle.
(CC) said wing arrangement may comprise a port wing and a starboard wing, each mounted to a corresponding side of said fuselage; alternatively, said wing arrangement may comprise a integral wing having a port wing part and a starboard wing part, and wherein said wing is mounted to said fuselage via a pylon structure, such that the dorsal surface of the fuselage is facing the underside of the integral wing.
(DD) in plan view or in bottom view at least a majority of each said sensor/emitter array is free from superposition by said wings.
(EE) at least one sensor/emitter array may include one or more of: a radar jammer arrangement, a passive radar detector, a SIGINT module, an ELINT module, and a COMINT module, a guard antenna, IFF (identify friend or foe) elements, radio transmitting elements, and so on.
(FF) the air vehicle may comprise one or more additional sensors or transmitters accommodated in said fuselage, for example in the aforesaid compartments. For example, the additional sensors or transmitters may include one or more of: a radar jammer arrangement, a passive radar detector, a SIGINT module, an ELINT module, and a COMINT module, a guard antenna, IFF (identify friend or foe) elements, radio transmitting elements, and so on.
(GG) in at least some embodiments the elongation axis of at least one said sensor/emitter array is generally aligned with the azimuthal reference plane of the air vehicle.
(HH) in at least some embodiments, at least one said sensor/emitter array is a planar array.
(II) in at least some embodiments, at least one said sensor/emitter array is a non-planar array—for example a curved array, or a multifaceted array having a plurality of facets that are not coplanar.
(JJ) in at least some embodiments, the air vehicle is free of additional tail arrangement, i.e., the air vehicle is tailless and is lacking empennage, and in other embodiments the air vehicle may comprise a suitable tail arrangement, i.e., an empennage.
(KK) in at least some embodiments, the fuselage comprises cross-sections at planes corresponding to locations of respective said sensor/emitter arrays, wherein a majority of each said cross-section is occupied by the respective said array. For example, in some such embodiments, more than 50% of each said cross-section is occupied by the respective said array. For example, in some such embodiments, more than 60% of each said cross-section is occupied by the respective said array. For example, in some such embodiments, more than 70% of each said cross-section is occupied by the respective said array. For example, in some such embodiments, more than 75% of each said cross-section is occupied by the respective said array. For example, in some such embodiments, more than 80% of each said cross-section is occupied by the respective said array. For example, in some such embodiments, more than 90% of each said cross-section is occupied by the respective said array. For example, in some such embodiments, more than 95% of each said cross-section is occupied by the respective said array. For example, in some such embodiments, more than 99% of each said cross-section is occupied by the respective said array.
(LL) in at least some embodiments, the fuselage has a profile that is generally determined by the size, shape and locations of said sensor/emitter arrays.
(MM) in at least some embodiments, the sensor/emitter arrays are arranged in said fuselage around an imaginary center point, wherein the sensor/emitter arrays are spaced from said center point by respective spacings which are dimensionally similar to one another. In at least some such embodiments, at least some of said spacings are not equal to one another, and wherein a maximum said spacing is larger than a minimum said spacing by less than a factor of P times said minimum spacing, wherein P may be any one of 1.5, 2, 3, 4, 5, 6, 7, 8, for example. Such a center point may be chosen, for example, to minimize the summation of said spacings.
(NN) in at least some embodiments, the sensor/emitter arrangement may be configured for at least one of sensing and emitting energy in directions associated with a plurality of different lines of sight (LOS) with respect to said fuselage, wherein at least some LOS are azimuthal lines of sight aligned with said azimuthal reference plane. In at least some embodiments, all the azimuthal LOS of the sensor/emitter arrangement are aligned with said azimuthal reference plane.
(OO) in at least some embodiments, the at least one azimuthal reference plane intersects the sensing/emitting face of at least one said sensor/emitter array, and preferably intersects the sensing/emitting face of each one of a plurality of said sensor/emitter arrays.

According to the first aspect of the invention there is also provided an air vehicle comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
wherein said fuselage is configured for integrating a sensor/emitter arrangement therein for enabling optimizing operation of said sensor/emitter arrangement, wherein said sensor/emitter arrangement comprises at least one sensor/emitter array, and preferably a plurality of said sensor/emitter arrays, the or each said sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

The air vehicle may be fitted with the sensor emitter arrangement and may additionally or alternatively optionally comprise one or more of the features (A) to (OO) as disclosed above, mutatis mutandis, in any desired combination or permutation, though according to this aspect of the invention the air vehicle is not limited to just these features.

According to a second aspect of the invention, there is provided an air vehicle comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
a sensor/emitter arrangement configured for at least one of sensing and emitting energy in directions associated with a plurality of different lines of sight (LOS) with respect to said fuselage;
said fuselage being configured for integrating said sensor/emitter arrangement therein for enabling optimizing operation of said sensor/emitter arrangement, and said fuselage comprising a fuselage fineness ratio including at least one of:
   (a) a first fineness ratio, taken as a ratio of said fuselage length to said fuselage height, wherein said first fineness ratio is less than about 5;
   (b) a second fineness ratio, taken as a ratio of said fuselage length to said fuselage width, wherein said first fineness ratio is less than about 6;
   (c) an inverse oblateness ratio, taken as a ratio of said fuselage width to said fuselage height, wherein said inverse oblateness ratio is greater than 1.5.

In some embodiments according to this aspect of the invention, the fuselage may comprise fineness ratios (a) or (b) or (c); or alternatively the fuselage may comprise fineness ratios [(a) and (b)], or [(a) and (c)], or [(b) and (c)]; or alternatively the fuselage may comprise fineness ratios (a) and (b) and (c).

The air vehicle according to this aspect of the invention may additionally or alternatively optionally comprise one or more of the features (A) to (OO) as disclosed above for the first aspect of the invention, mutatis mutandis, in any desired combination or permutation, though according to this aspect of the invention the air vehicle is not limited to just these features. For example, the sensor/emitter arrangement may comprise at least one sensor/emitter array comprising a sensing/emitting face that is elongated with respect to an elongation axis, and at least one said sensor/emitter array may be arranged with the respective sensing/emitting face thereof at least partially facing one of a forward direction and an aft direction along said longitudinal axis, and at least partially facing at least one side direction along said pitch axis.

According to the second aspect of the invention, there is also provided an air vehicle comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle the air vehicle further defining at least one azimuthal reference plane that intersects said fuselage;
said fuselage being configured for integrating a sensor/emitter arrangement therein for enabling optimizing operation of said sensor/emitter arrangement, the sensor/emitter arrangement configured for at least one of sensing and emitting energy in directions associated with a plurality of different lines of sight (LOS) with respect to said fuselage, including a forward direction and an aft direction; and said fuselage comprising a fuselage fineness ratio including at least one of:
   (a) a first fineness ratio, taken as a ratio of said fuselage length to said fuselage height, wherein said first fineness ratio is less than about 5;
   (b) a second fineness ratio, taken as a ratio of said fuselage length to said fuselage width, wherein said first fineness ratio is less than about 6;
   (c) an inverse oblateness ratio, taken as a ratio of said fuselage width to said fuselage height, wherein said inverse oblateness ratio is greater than 1.5.

In some embodiments according to this aspect of the invention, the fuselage may comprise fineness ratios (a) or (b) or (c); or alternatively the fuselage may comprise fineness ratios [(a) and (b)], or [(a) and (c)], or [(b) and (c)]; or alternatively the fuselage may comprise fineness ratios (a) and (b) and (c).

The air vehicle may be fitted with the sensor emitter arrangement and may additionally or alternatively optionally comprise one or more of the features (A) to (OO) as disclosed above, mutatis mutandis, in any desired combination or permutation, though according to this aspect of the invention the air vehicle is not limited to just these features.

According to a third aspect of the invention, there is provided an air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle the air vehicle further defining at least one azimuthal reference plane that intersects said fuselage;
a sensor/emitter arrangement configured for at least one of sensing and emitting energy in directions associated with a plurality of different lines of sight (LOS) with respect to said fuselage;
the fuselage being configured for integrating said sensor/emitter arrangement therein for enabling optimizing operation of said sensor/emitter arrangement;
wherein said sensor/emitter arrangement comprises at least one said planar sensor/emitter array that is elongated along an elongation axis generally aligned with an azimuthal volume with respect to the air vehicle, said sensor/emitter array having a field of view that at least partially faces a forward direction or an aft direction along said longitudinal axis
the air vehicle further comprising a dorsal-mounted propulsion system.

In some embodiments according to this aspect of the invention the air vehicle is free of additional tail arrangement, i.e., lacking empennage, and in other embodiments the air vehicle may comprise a suitable tail arrangement, i.e., an empennage.

The air vehicle according to this aspect of the invention may additionally or alternatively optionally comprise one or more of the features (A) to (E), (G) to (T), (V) to (OO) as disclosed above for the first aspect of the invention, mutatis mutandis, in any desired combination or permutation, though according to this aspect of the invention the air vehicle is not limited to just these features.

According to a fourth aspect of the invention, there is provided an air vehicle comprising:

a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;

a sensor/emitter arrangement configured for at least one of sensing and emitting energy in directions associated with a plurality of different lines of sight (LOS) with respect to said fuselage;

the fuselage being configured for integrating said sensor/emitter arrangement therein for enabling optimizing operation of said sensor/emitter arrangement;

the air vehicle being free of additional tail arrangement.

The air vehicle according to this aspect of the invention may additionally or alternatively optionally comprise one or more of the features (A) to (II), and (KK) to (OO) as disclosed above for the first aspect of the invention, mutatis mutandis, in any desired combination or permutation, though according to this aspect of the invention the air vehicle is not limited to just these features. For example, the sensor/emitter arrangement may comprise at least one sensor/emitter array comprising a sensing/emitting face that is elongated with respect to an elongation axis, and at least one said sensor/emitter array may be arranged with the respective sensing/emitting face thereof at least partially facing one of a forward direction and an aft direction along said longitudinal axis, and at least partially facing at least one side direction along said pitch axis.

According to the fourth aspect of the invention, there is also provided an air vehicle comprising:

a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;

the fuselage being configured for integrating a sensor/emitter arrangement therein for enabling optimizing operation of said sensor/emitter arrangement, the sensor/emitter arrangement being configured for at least one of sensing and emitting energy in directions associated with a plurality of different lines of sight (LOS) with respect to said fuselage;

the air vehicle being free of additional tail arrangement.

The air vehicle may be fitted with the sensor emitter arrangement and may additionally or alternatively optionally comprise one or more of the features (A) to (II), and (KK) to (OO) as disclosed above, mutatis mutandis, in any desired combination or permutation, though according to this aspect of the invention the air vehicle is not limited to just these features.

According to a fifth aspect of the invention, there is provided an airborne radar system configured for providing surveillance coverage throughout at least a portion of a 360 degree azimuth volume, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle;
a radar system comprising a plurality of antenna structures, each having a respective field of view, the air vehicle further defining at least one azimuthal reference plane that intersects said fuselage;
the fuselage comprising a plurality of internal compartments peripherally disposed with respect thereto and each compartment configured for enabling integrating therein a respective said antenna structure;
wherein at least one said antenna structure comprises a respective sensing/emitting face that is elongated along an elongation axis and is arranged with the respective sensing/emitting face thereof at least partially facing one of a forward direction and an aft direction along said longitudinal axis, and at least partially facing at least one side direction along said pitch axis.

The air vehicle according to this aspect of the invention may comprise one or more of the following features in any desired combination or permutation, though according to this aspect of the invention the air vehicle is not limited to just these features:
said elongation axis may be generally aligned with an azimuthal plane of said air vehicle corresponding to said azimuthal volume, for example the azimuthal reference plane.
said vehicle comprises an inverse oblateness ratio, taken as a ratio of said fuselage width to said fuselage height, greater than about 1.5.
said fuselage comprises a first fineness ratio, taken as a ratio of said fuselage length to said fuselage width, of less than about 5.0 or less than about 2.0.
said antenna structures each comprises a radar array, each radar array being configured for providing radar data for a respective portion of said 360 degree azimuth volume with respect to the air vehicle, referenced to said at least one azimuthal reference plane.
said radar system is configured for providing said radar data for a substantially continuous 360 degree azimuth volume with respect to the air vehicle, referenced to said azimuthal reference plane.
said wing arrangement lacks any portions thereof that intersect with or that is below said azimuthal reference plane.
in at least some embodiments, at least one said antenna structure may be arranged with the respective sensing/emitting face thereof facing one of said forward direction and said aft direction.
in at least some embodiments, at least one said radar array is arranged with the respective elongation axis thereof substantially parallel to said pitch axis of the air vehicle, and located at an aft end of said fuselage.
said aft end comprises an aerodynamically blunt aft end.
at least a majority of said aft end is closed and lacks a streamlined configuration.
said aft end comprises a cross-section that is generally rounded in at least a majority of cross-sections taken perpendicular to the azimuthal reference plane and generally parallel to the longitudinal axis of the air vehicle.
at least one said radar array is arranged with the respective elongation axis thereof substantially inclined to said pitch axis and to said longitudinal axis, in plan view.
at least one said inclined elongation axis is inclined at an angle between about 10 degrees and about 80 degrees with respect to said longitudinal axis, in plan view.
at least one said inclined elongation axis is inclined at one of an angle of about 30 degrees or an angle of 60 degrees with respect to said longitudinal axis, in plan view.
the vehicle may comprise three said arrays, arranged with the respective elongate axes along the sides of an imaginary triangle; for example, said triangle may an equilateral triangle or an isosceles triangle.
the air vehicle may comprise four or more said radar arrays, arranged with their respective elongate axes in symmetrical disposition with respect to said longitudinal axis.
at least one said elongation axis is inclined at an angle of about 45 degrees with respect to said longitudinal axis.
each radar array has an array height dimension and an array width dimension, taken orthogonal to and along with, respectively, the elongate direction, and an aspect ratio of array width to array height for at least one said array is between about 1.5 and about 10.
each said radar array being further configured for providing said sensor data in elevation below said azimuthal reference plane, at least for a respective portion of a 360 degree azimuth volume.
said radar arrangement is configured for providing said radar data from a hemispherical envelope centered on said fuselage and extending radially below said azimuthal reference plane.
each said radar array being further configured for providing said radar data in elevation above said azimuthal reference plane, at least for a respective portion of said 360 degree azimuth volume.
said radar system is configured for providing said radar data for in elevation above said azimuthal reference plane, for said 360 degree azimuth volume excluding portions thereof associated with said wing arrangement.
said radar arrays are configured for providing substantially similar radar performance one to another, at least with respect to one of: maximum range, field of view in azimuth, field of view in elevation with respect to said azimuthal reference plane.
said radar arrays comprise phase radar arrays.
said air vehicle comprises a propulsion system dorsally mounted on said fuselage.
said air vehicle is configured as a UAV or as a manned air vehicle.
said air vehicle is configured as having at least one of an empty weight in excess of about 6,500 Kg, and a minimum speed in excess of about Mach 0.15.
said air vehicle is configured as a subsonic or a transonic air vehicle.
each said radar array is mounted in a respective said compartment in said fuselage and facing a fairing that forms part of the outer skin of the air vehicle.
said fairings are made from a material that is substantially transparent to the radar beams transmitted from and/or received by the respective radar array.
said fairings each comprise a smooth rounded shape.
said fuselage has an outer surface that is faceted, and wherein each said radar array comprises a respective said fairing that is substantially flat and spaced from the respective sensor array, and which forms part of an external skin of said air vehicle.
In some embodiments, the wing arrangement comprises a port wing and a starboard wing, each mounted to a corresponding side of said fuselage, and at least in some other embodiments, the wing arrangement comprises an integral wing having a port wing part and a starboard wing part, and wherein said wing is mounted to said fuselage via a pylon structure, such that the dorsal surface of the fuselage is facing the underside of the integral wing.
wherein in plan view or in bottom view at least a majority of each said radar array is free from superposition by said wings.
the air vehicle being free of additional tail arrangement.
further comprising one or more additional sensors or transmitters accommodated in the fuselage particularly in said compartments; for example, the additional sensors or transmitters may include one or more of a radar jammer arrangement, a passive radar detector, a SIGINT module, an ELINT module, and a COMINT module, a guard antenna, IFF (identify friend or foe) elements, radio transmitting elements.
in at least some embodiments, said fuselage comprises cross-sections at planes corresponding to locations of respective said radar arrays, wherein a majority of each said cross-section is occupied by the respective said array.
in at least some embodiments, said fuselage has a profile that is generally determined by the size, shape and locations of said radar arrays.
in at least some embodiments, said sensor/emitter arrays are arranged in said fuselage around an imaginary center point, wherein the radar arrays are spaced from said center point by respective spacings which are dimensionally similar to one another; in at least some embodiments, at least some of said spacings are not equal to one another, and wherein a maximum said spacing is larger than a minimum said spacing by less than a factor of P times said minimum spacing, wherein P may be any one of 1.5, 2, 3, 4, 5, 6, 7, 8, for example. Such a center point may be chosen, for example, to minimize the summation of said spacings.
in at least some embodiments, the radar system may be configured for at least one of sensing and emitting energy in directions associated with a plurality of different lines of sight (LOS) with respect to said fuselage, wherein at least some LOS are aligned with said azimuthal reference plane. In at least some embodiments, all the azimuthal LOS of the radar system are aligned with said azimuthal reference plane.
in at least some embodiments, the at least one azimuthal reference plane intersects the sensing/emitting face of at least one said antenna structure, and preferably intersects the sensing/emitting face of each one of a plurality of said antenna structure.

According to the fifth aspect of the invention, there is also provided an air vehicle configured for incorporating an airborne radar system configured for providing surveillance coverage throughout at least a portion of a 360 degree azimuth volume, the air vehicle comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
the fuselage comprising a plurality of internal compartments peripherally disposed with respect thereto and each compartment configured for enabling integrating therein a respective antenna structure of a radar system comprising a plurality of said antenna structures, each having a respective field of view, wherein at least one said antenna structure comprises a respective sensing/emitting face that is elongated along an elongation axis and is arranged with the respective sensing/emitting face thereof at least partially facing one of a forward direction and an aft direction along said longitudinal axis, and at least partially facing at least one side direction along said pitch axis.

The air vehicle may be fitted with the sensor emitter arrangement and may additionally or alternatively optionally comprise one or more of the features as disclosed above in the list of bullets, mutatis mutandis, in any desired combination or permutation, though according to this aspect of the invention the air vehicle is not limited to just these features.

According to a sixth aspect of the invention, there is provided an air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
the fuselage comprising a blunt aft end, i.e., an aerodynamically blunt aft end; and
the air vehicle being free of additional tail arrangement.

In at least some embodiments according to this aspect of the invention, said fuselage is configured for integrating said sensor/emitter arrangement therein for enabling optimizing operation of said sensor/emitter arrangement, wherein said sensor/emitter arrangement comprises at least one sensor/emitter array comprising a sensing/emitting face that is elongated with respect to an elongation axis, and configured for enabling at least one said sensor/emitter array to be arranged with the respective sensing/emitting face thereof at least partially facing one of a forward direction and an aft direction along said longitudinal axis, and at least partially facing at least one side direction along said pitch axis.

In at least these or other embodiments according to this aspect of the invention the air vehicle further comprises the sensor/emitter arrangement, wherein the sensor/emitter arrangement is configured for at least one of sensing and emitting energy in directions associated with a plurality of different lines of sight (LOS) with respect to said fuselage. The sensor/emitter arrangement may comprise at least one sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

The air vehicle according to this aspect of the invention may optionally comprise one or more of the features (A) to (F) and (H) to (OO) as disclosed above for the first aspect of the invention, mutatis mutandis, in any desired combination or permutation, though according to this aspect of the invention the air vehicle is not limited to just these features.

According to a seventh aspect of the invention, there is provided an air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
said fuselage comprising a blunt aft end; and
said fuselage comprising a fuselage fineness ratio including at least one of:
   (a) a first fineness ratio, taken as a ratio of said fuselage length to said fuselage height, wherein said first fineness ratio is less than about 5;
   (b) a second fineness ratio, taken as a ratio of said fuselage length to said fuselage width, wherein said first fineness ratio is less than about 6;
   (c) an inverse oblateness ratio, taken as a ratio of said fuselage width to said fuselage height, wherein said inverse oblateness ratio is greater than 1.5.

In some embodiments according to this aspect of the invention, the fuselage may comprise fineness ratios (a) or (b) or (c); or alternatively the fuselage may comprise fineness ratios [(a) and (b)], or [(a) and (c)], or [(b) and (c)]; or alternatively the fuselage may comprise fineness ratios (a) and (b) and (c).

In at least some embodiments according to this aspect of the invention, said fuselage is configured for integrating said sensor/emitter arrangement therein for enabling optimizing operation of said sensor/emitter arrangement, wherein said sensor/emitter arrangement comprises at least one sensor/emitter array comprising a sensing/emitting face that is elongated with respect to an elongation axis, and configured for enabling at least one said sensor/emitter array to be arranged with the respective sensing/emitting face thereof at least partially facing one of a forward direction and an aft direction along said longitudinal axis, and at least partially facing at least one side direction along said pitch axis.

In at least these or other embodiments according to this aspect of the invention the air vehicle further comprises the sensor/emitter arrangement, wherein the sensor/emitter arrangement is configured for at least one of sensing and emitting energy in directions associated with a plurality of different lines of sight (LOS) with respect to said fuselage. The sensor/emitter arrangement may comprise at least one sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

The air vehicle according to this aspect of the invention may optionally comprise one or more of the features (A) to (F) and (H) to (OO) as disclosed above for the first aspect of the invention, mutatis mutandis, in any desired combination or permutation, though according to this aspect of the invention the air vehicle is not limited to just these features.

According to an eighth aspect of the invention, there is provided an air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
the fuselage comprising a plurality of internal compartments peripherally disposed with respect thereto and configured for enabling integrating therein sensor/emitter arrangement that is configured for at least one of sensing and emitting energy in directions associated with a plurality of different lines of sight (LOS) with respect to said fuselage;
said fuselage comprising a fuselage fineness ratio including at least one of:
   (a) a first fineness ratio, taken as a ratio of said fuselage length to said fuselage height, wherein said first fineness ratio is less than about 5;
   (b) a second fineness ratio, taken as a ratio of said fuselage length to said fuselage width, wherein said first fineness ratio is less than about 6;
   (c) an inverse oblateness ratio, taken as a ratio of said fuselage width to said fuselage height, wherein said inverse oblateness ratio is greater than 1.5.

In some embodiments according to this aspect of the invention, the fuselage may comprise fineness ratios (a) or (b) or (c); or alternatively the fuselage may comprise fineness ratios [(a) and (b)], or [(a) and (c)], or [(b) and (c)]; or alternatively the fuselage may comprise fineness ratios (a) and (b) and (c).

In at least some embodiments according to this aspect of the invention, said fuselage is configured for integrating said sensor/emitter arrangement therein for enabling optimizing operation of said sensor/emitter arrangement, wherein said sensor/emitter arrangement comprises at least one sensor/emitter array comprising a sensing/emitting face that is elongated with respect to an elongation axis, and configured for enabling at least one said sensor/emitter array to be arranged with the respective sensing/emitting face thereof at least partially facing one of a forward direction and an aft direction along said longitudinal axis, and at least partially facing at least one side direction along said pitch axis.

In at least these or other embodiments according to this aspect of the invention the air vehicle further comprises the sensor/emitter arrangement, wherein the sensor/emitter arrangement is configured for at least one of sensing and emitting energy in directions associated with a plurality of different lines of sight (LOS) with respect to said fuselage. The sensor/emitter arrangement may comprise at least one sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

The air vehicle according to this aspect of the invention may optionally comprise one or more of the features (A) to (F) and (H) to (OO) as disclosed above for the first aspect of the invention, mutatis mutandis (wherein the compartments mentioned in feature (Y), are the above-mentioned compartments peripherally disposed with respect the fuselage), in any desired combination or permutation, though according to this aspect of the invention the air vehicle is not limited to just these features.

According to a ninth aspect of the invention, there is provided a method for generating an air vehicle configuration, comprising:
(i) providing geometrical specifications of a plurality of sensors/emitters;
(ii) providing desired relative spatial relationships between said sensors/emitters
(iii) providing a fairing configuration for each sensor/emitter, the respective fairing configuration being configured for minimizing interference with sensor/emitter operation of the respective sensor via the respective fairing;
(iv) generating a fuselage configuration including an outer fuselage skin enclosing a fuselage volume, wherein said sensors/emitters are integrated within said fuselage volume in said desired relative spatial relationships, wherein said fairing configurations form part of said fuselage skin, and optimizing said fuselage configuration to provide optimal aerodynamic performance according to predetermined criteria, while substantially maintaining minimal interference of said fairing configuration with said sensor/emitter operation;
(v) providing a wing arrangement in fixed-wing relationship to said fuselage.

The air vehicle according to this aspect of the invention may comprise one or more of the following features in any desired combination or permutation, though according to this aspect of the invention the air vehicle is not limited to just these features:
(a) said air vehicle comprises a longitudinal axis, and wherein said fuselage comprises a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage.
(b) at least a part of said fuselage may be formed having a generally oblate cross-section perpendicular to said longitudinal axis for accommodating therein at least a portion of said sensor/emitter arrangement.
(c) said fuselage may be formed with an inverse oblateness ratio, taken as a ratio of said fuselage width to said fuselage height, greater than unity, for example, the inverse oblateness ratio may be greater than about 1.5.
(d) said fuselage may be formed with a first fineness ratio, taken as a ratio of said fuselage length to said fuselage width, of less than about 5.0, or less than about 2.0.
(e) each said sensor may comprise a planar sensor/emitter array.
(f) configuring said air vehicle as a tailless air vehicle.
(g) said wing arrangement may be configured to lack any portions thereof that intersect with or that is below the azimuthal reference plane with respect to the air vehicle.
(h) each said sensor/emitter array may comprise a sensing/emitting face that is elongated with respect to an elongation axis.
(i) said desired relative spatial relationships may include arranging at least one said sensor/emitter array with the respective sensing/emitting face thereof at least partially facing one of a forward direction and an aft direction along said longitudinal axis, and at least partially facing at least one side direction along said pitch axis. Additionally or alternatively, said desired relative spatial relationships include arranging at least one said sensor/emitter array with the respective elongation axis thereof substantially parallel to said pitch axis of the air vehicle, and locating the respective array at an aft end of said fuselage.
(j) the aft end of the fuselage may be formed as an aerodynamically blunt aft end.
(k) at least a majority of the aft end of the fuselage may be closed and formed lacking a streamlined configuration.
(l) the aft end of the fuselage may be formed with a cross-section that is generally rounded in at least a majority of cross-sections taken perpendicular to the azimuthal reference plane and generally parallel to the longitudinal axis of the air vehicle.
(m) the desired relative spatial relationships may include arranging at least one said sensor/emitter array with the respective elongation axis thereof substantially inclined to said pitch axis and to said longitudinal axis, in plan view; for example at least one said inclined elongation axis may inclined at an angle between about 10 degrees and about 80 degrees with respect to said longitudinal axis, in plan view.
(n) as a further example of feature (m), at least one said inclined elongation axis is inclined at one of an angle of about 30 degrees or an angle of 60 degrees with respect to said longitudinal axis, in plan view, and furthermore, as a further example, three said sensor/emitter arrays are integrated in said fuselage volume, arranged with the respective elongate axes along the sides of an imaginary triangle, for example an isosceles triangle or an equilateral triangle.
(o) as another example of feature (m), four or more said sensor/emitter arrays are integrated in said fuselage volume, arranged with their respective elongate axes in symmetrical disposition with respect to said longitudinal axis.
(p) as another example of feature (m) and/or of feature (o), at least one said elongation axis is inclined at an angle of about 45 degrees with respect to said longitudinal axis.
(q) as another example of feature (m) and/or of feature (o) and/or feature (p), the sensor/emitter arrays may be arranged in substantially diamond-shape arrangement or rectangular arrangement in plan view when four sensor/emitter arrays are used, or may comprise five sensor/emitter arrays in pentagon arrangement in plane view, or indeed any suitable number of arrays may be provided in any suitable polygonal arrangement in plan view.
(r) the geometrical specifications may comprise an array height dimension and an array width dimension for each sensor/emitter array, taken orthogonal to and along with, respectively, the elongate direction, and an aspect ratio of array width to array height for at least one said sensor/emitter array is between about 1.5 and about 10.
(s) positioning each said sensor/emitter array in said fuselage volume such to enable operation thereof in elevation below said azimuthal reference plane, at least for a respective portion of a 360 degree azimuth volume. For example, the sensors/emitters may be arranged in said fuselage volume to enable operation thereof with respect to a hemispherical envelope centered on said fuselage and extending radially below said azimuthal reference plane.
(t) each said sensor/emitter array being positioned in said fuselage volume such to enable operation thereof in elevation above said azimuthal reference plane, at least for a respective portion of said 360 degree azimuth volume. For example, said sensors/emitters may be arranged in said fuselage volume to enable operation thereof with respect to elevation above said azimuthal reference plane, for said 360 degree azimuth volume excluding portions thereof associated with said wing arrangement.
(u) the sensor/emitter arrays may be similarly dimensioned one to another.
(v) comprising dorsally mounting a propulsion system to said fuselage.
(w) configuring the air vehicle as a UAV or as a manned air vehicle.
(x) configuring said air vehicle as having at least one of an empty weight in excess of about 6,500 Kg, and a minimum speed in excess of about Mach 0.15.
(y) configuring said air vehicle as a subsonic or a transonic air vehicle.
(z) forming said fuselage volume with a plurality of compartments, each said sensor/emitter array being comprised in a respective compartment in said fuselage and facing a respective said fairing. In some examples, at least one said fairing is made from a material that is substantially transparent to the radar beams transmitted from and/or received therethrough.
(aa) in some embodiments, the fairings are each formed comprising a smooth rounded shape.
(bb) in other embodiments, the fuselage skin is faceted, and wherein each said sensor/emitter array comprises a respective said fairing that is substantially flat and spaced from the respective sensor/emitter array, and which forms part of said fuselage skin.
(cc) in some embodiments, the wing arrangement is formed as a port wing and a starboard wing, and mounting each wing to a corresponding side of said fuselage.
(dd) in other embodiments, the wing arrangement is formed as an integral wing having a port wing part and a starboard wing part, and comprising mounting the integral wing to said fuselage via a pylon structure, such that the dorsal surface of the fuselage is facing the underside of the wing.
(ee) the sensor/emitter arrays and the wing arrangement may be arranged with respect to the fuselage such that in plan view or in bottom view at least a majority of each said sensor/emitter array is free from superposition by said wings.
(ff) for example, said sensor/emitter arrays are radar arrays, for example phased arrays.
(gg) the said elongation axis may be generally aligned with an azimuthal plane of said air vehicle.
(hh) said fuselage may be formed with cross-sections at planes corresponding to locations of respective said sensor/emitter arrays, wherein a majority of each said cross-section is occupied by the respective said array.
(ii) said fuselage may have a profile that is generally determined by the size, shape and locations of said sensor/emitter arrays.
(jj) the sensor/emitter arrays may be arranged in said fuselage around an imaginary center point, wherein the sensor/emitter arrays are spaced from said center point by respective spacings which are dimensionally similar to one another. For example, at least some of said spacings are not equal to one another, and wherein a maximum said spacing is larger than a minimum said spacing by less than a factor of P times said minimum spacing, wherein P may be any one of 1.5, 2, 3, 4, 5, 6, 7, 8, for example.

According to another aspect of the invention there is provided a sensor/emitter arrangement is integrated into the fuselage structure of a specially designed air vehicle, in which the air vehicle is configured for optimizing operation of the sensor/emitter arrangement with respect to at least azimuthal lines of sight radiating along a azimuthal reference plane of the air vehicle. The azimuthal reference plane intersects the air vehicle fuselage. In at least some embodiments, the fuselage is formed with a plurality of oblate cross-sections that facilitate maximizing the room available for a sensor/emitter array that is elongated along an elongate axis that may be aligned with the azimuthal reference plane. In at least some embodiments one or more such elongate axes may be inclined to the longitudinal (roll) axis and the pitch axis of the air vehicle. In at least some embodiments, the air vehicle may have a blunt aft end incorporating an elongate aft-facing sensor/emitter array. The air vehicle may additionally or alternatively optionally comprise one or more of the features (A) to (OO) as disclosed above, mutatis mutandis, in any desired combination or permutation, though according to this aspect of the invention the air vehicle is not limited to just these features.

Other optional features for the above aspects of the invention may include providing the air vehicle with one or more of: a communication system for transmitting and/or receiving data; storage system for storing data obtained from operation of sensors etc.

Herein, by “sensor/emitter arrangement”, “sensor/emitter”, or “sensor/emitter array” is meant an arrangement, a unit and an array, respectively, configured for and capable of at least one of sensing and emitting energy in a direction along a sensing/emitting line of sight (LOS), for respectively sensing and/or emitting energy, for example with respect to a target. Such energy may be, for example acoustic energy, or alternatively electromagnetic energy. In the latter case, the respective sensor/emitter arrangement, sensor/emitter, or sensor/emitter array may operate as one or more of a passive or active radar, rangefinder, image acquisition, communication system, and so on, depending on the electromagnetic wavelength used in operation, and whether the respective sensor/emitter arrangement, sensor/emitter, or sensor/emitter array is used for receiving and/or for emitting (emitting being used interchangeably herein with transmitting) the respective energy.

According to each of the above aspects of the present invention, any aforementioned sensor/emitter arrangement, sensor/emitter, sensor/emitter module, or sensor/emitter array may be replaced with a sensor arrangement, sensor, sensor module, or sensor array, respectively, or with a emitter arrangement, emitter, emitter module, or emitter array, respectively.

Thus, according to at least the above aspects, the present invention provides a new and inventive approach to airborne sensor platforms and the like, in which an air vehicle may be purpose-designed to optimize operation of the sensors/emitters, for example to provide an effective airborne radar surveillance platform. This approach is radically opposed to the current retrofit approach to such platforms, which attempt to incorporate a radar system in an existing airframe. Thus, according to at least some aspects of the invention, an improved design approach is provided for airborne platform having one or more intelligence, surveillance or reconnaissance (ISR) capabilities, in which the airborne platform comprises a fuselage and wings fixed thereto, wherein the body is designed based on providing a suitable envelope for a desired sensor/emitter arrangement.

A feature of at least some embodiments of the present invention is that the potential for parts of the air vehicle interfering with sensor/emitter operation, for example radar operation may be minimized. For example, when using phased radar arrays having lobe-shaped footprints, the arrays may be provided in a configuration comprising an aft-looking array and at least two side arrays are provided, each side array being at an angle to the aft array on the azimuthal plane. In such a configuration, the wings of the air vehicle may be designed to have their span direction generally inbetween the respective side array and the aft array, such as to align with the minimum range direction of the arrays, and thus minimally disrupt operation in upward elevation. Furthermore, at least some embodiments lack a tail, and also provide the wings above the azimuthal plane, thereby minimizing interference with sensor/emitter operation, allowing a full panoramic azimuth filed of view, as well as elevation filed of view in the downward direction. In embodiments where, rather than a look-down capability, a look-up capability is preferred, the wings (and where applicable, the powerplant as well) may be provided below the azimuthal plane, substantially eliminating potential sources of interference with sensor/emitter operation.

Another feature of at least some embodiments of the present invention is that a sensor/emitter such as a radar antenna array may be placed in an aft-facing position, the array having an elongated form along the azimuthal plane to provide coverage of a relatively wide sector in azimuth while the height of the antenna array can be maximized with respect to the fuselage height dimension, for example as compared with current AEW designs which use a relatively small radar antenna aft.

In addition, the height of the antenna array can also be relatively large with respect to the fuselage, as the fairing provided for the array provides the fuselage with a blunt aft end, compared with relatively smaller heights that are possible with streamlined fuselage aft ends (especially when absent any empennage in such streamlined aft ends). The larger antenna array height provides relatively improved coverage in elevation.

Another feature of at least some embodiments of the invention is that the aft-facing function of the sensor/emitter arrangement may be achieved by providing two arrays in V-configuration, where the apex of the V is aft-facing along the longitudinal axis of the vehicle.

Another feature of at least some embodiments of the invention is that the sensor/emitter arrangement comprises phased radar antenna arrays, which allow an electromagnetic radar beam to be electronically steered, making a physically rotating rotodome or antenna unnecessary.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is top/front/side isometric view of a first embodiment of the invention.

FIG. 2 is bottom/front/side isometric view of the embodiment of FIG. 1.

FIG. 3 is top/rear/side isometric view of the embodiment of FIG. 1.

FIG. 4 is bottom/rear/side isometric view of the embodiment of FIG. 1.

FIG. 5 is front view of the embodiment of FIG. 1.

FIG. 6 is rear view of the embodiment of FIG. 1.

FIG. 7 is side view of the embodiment of FIG. 1.

FIG. 8 is top view of the embodiment of FIG. 1.

FIG. 9 is bottom view of the embodiment of FIG. 1.

FIGS. 10a to 10e show the sensor modules of the embodiment of FIG. 1: FIG. 10a in top view; FIG. 10b in side view; FIG. 10c in rear view; FIG. 10d in front view; FIG. 10e is a cross-section taken at A-A in FIG. 10a.

FIG. 11 illustrates schematically in plan view the azimuthal ranges obtained with the embodiment of FIG. 1 with respect to the azimuthal reference plane; FIG. 11a illustrates schematically in side view the elevational ranges associated with the embodiment of FIG. 1, with respect to the azimuthal reference plane.

FIGS. 12a and 12b illustrate, in bottom/rear/side isometric view and in top/front/side isometric view, respectively, the inside structure of the body of the embodiment of FIG. 1.

FIG. 13 illustrates, in top/rear/side isometric view, respectively, the sensor modules of the embodiment of FIG. 1.

FIG. 14 is a top view of a second embodiment of the invention; FIG. 14a is a cross-sectional view of the embodiment of FIG. 14 taken along A1-A1; FIG. 14b is a cross-sectional view of the embodiment of FIG. 14 taken along A2-A2; FIG. 14c is a side view of the embodiment of FIG. 19.

FIG. 15 and FIG. 15a are a top view and a side view of a variation of the embodiment of FIG. 14.

FIG. 16 is a top view of a third embodiment of the invention.

FIG. 17 is a top view of a fourth embodiment of the invention.

FIG. 18 and FIG. 18a are a top view and a side view of a fifth embodiment of the invention.

FIG. 19 is a top view of a sixth embodiment of the invention; FIG. 19a is a cross-sectional view of the embodiment of FIG. 19 taken along B1-B1; FIG. 19b is a cross-sectional view of the embodiment of FIG. 19 taken along B2-B2.

FIG. 20 is a top view of a seventh embodiment of the invention.

FIG. 21 is a top view of an eighth embodiment of the invention.

FIG. 22 is an isometric top/side/front view of the forward mounted sensor emitter array of the embodiment of FIG. 21.

FIG. 23 is an isometric top/side/back view of the aft mounted sensor emitter array of the embodiment of FIG. 21.

### DETAILED DESCRIPTION OF EMBODIMENTS

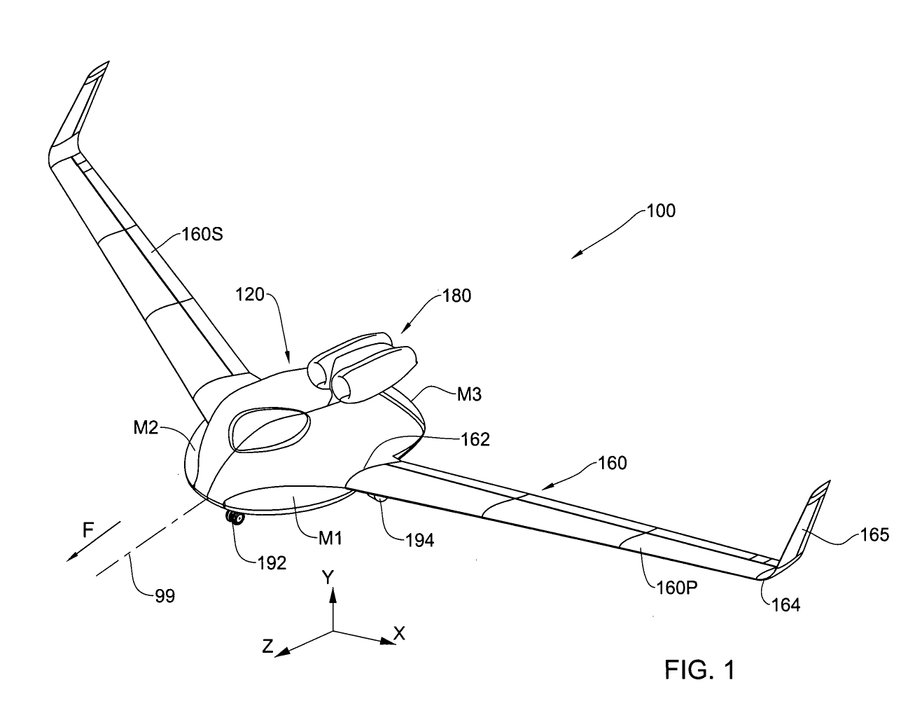

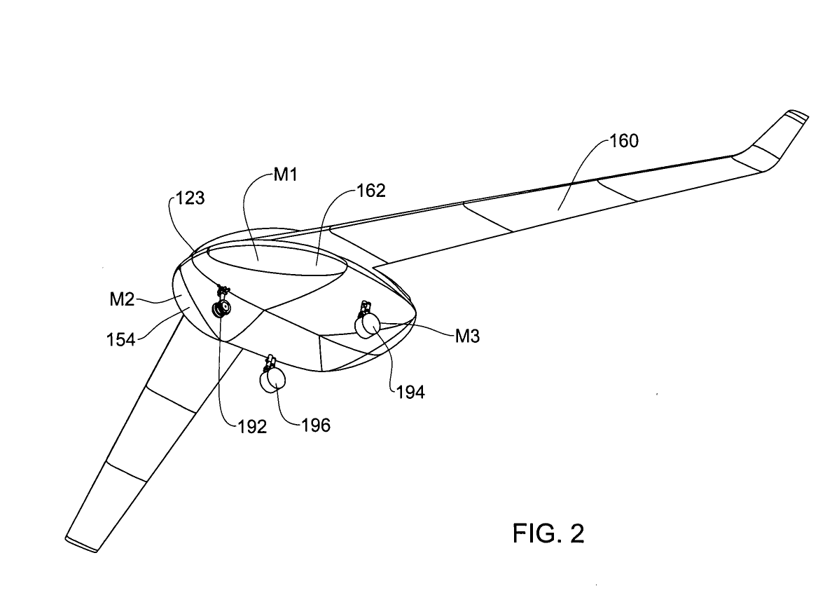

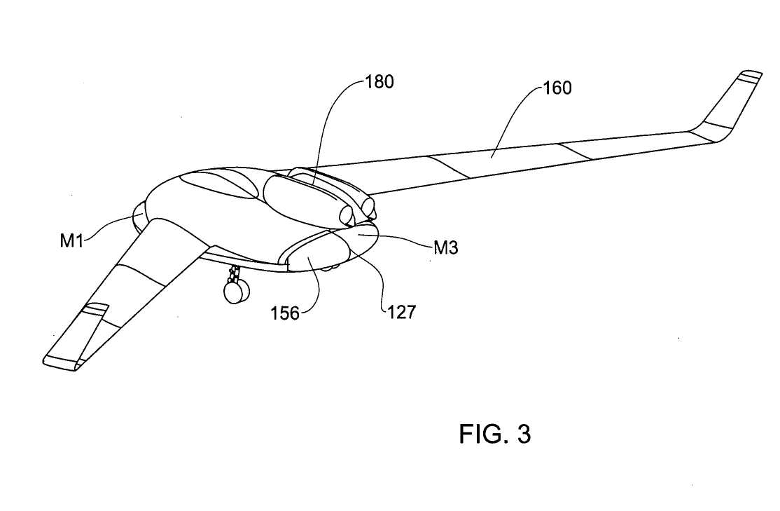

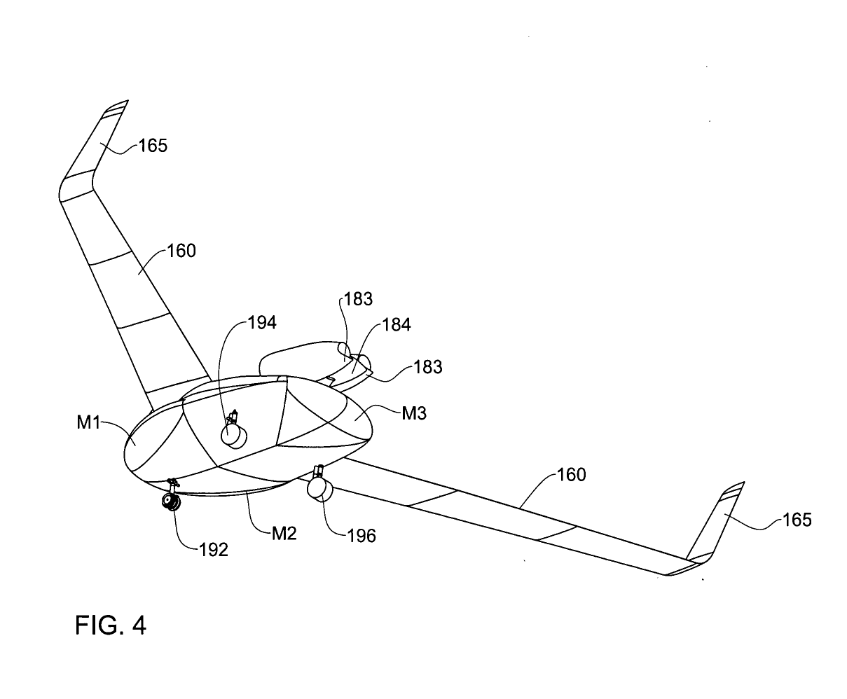

Referring to FIGS. 1 to 9, an air vehicle according to a first embodiment of the invention, generally designated 100, comprises a body in the form of fuselage 120, wings 160, sensor/emitter module system M, and propulsion system 180. In the illustrated embodiment, the air vehicle 100 is configured as a subsonic, fixed wing, unmanned air vehicle (UAV). In alternative variations of this embodiment, and in other embodiments, the air vehicle may be configured as a manned subsonic air vehicle, or may be configured as a manned or unmanned supersonic air vehicle or as a manned or unmanned transonic air vehicle.

In the illustrated embodiment, the air vehicle 100 is configured as a surveillance or Airborne Early Warning (AEW) aircraft, providing primarily radar based data on location, and velocity vectors of targets. In alternative variations of this embodiment, the air vehicle may be configured as a SIGINT and/or Electronic Warfare aircraft, for example.

Furthermore, in this and at least in some other embodiments the air vehicle is configured for operating at flight speeds in excess of about Mach 0.15 and has an empty weight in excess of 4,500 Kg, although in alternative variations of this embodiment or in yet other embodiments the air vehicle may be configured for operating at flight speeds less than about Mach 0.15 and/or may have an empty weight less than 4,500 Kg.

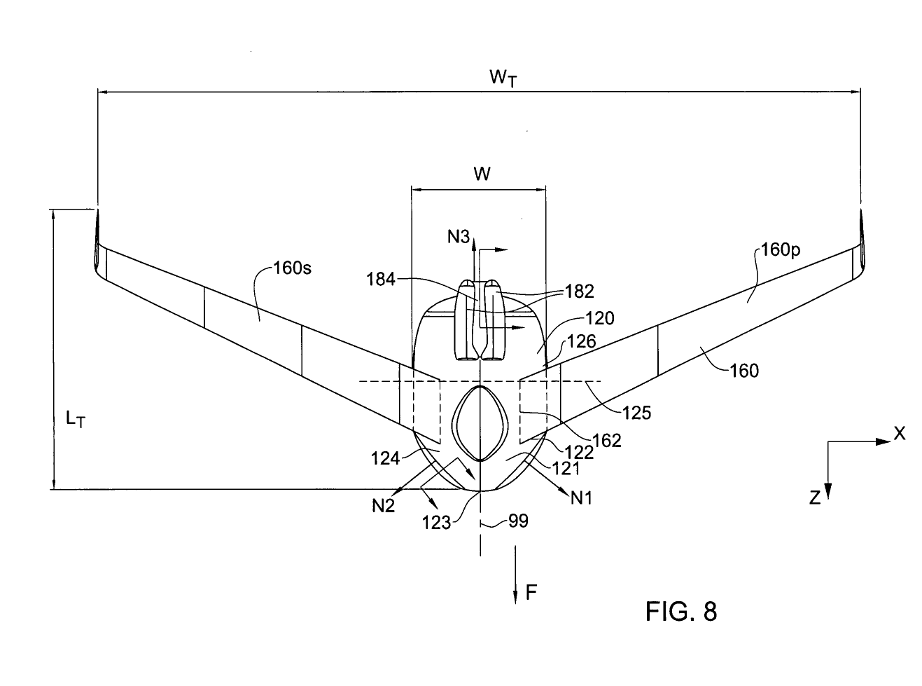

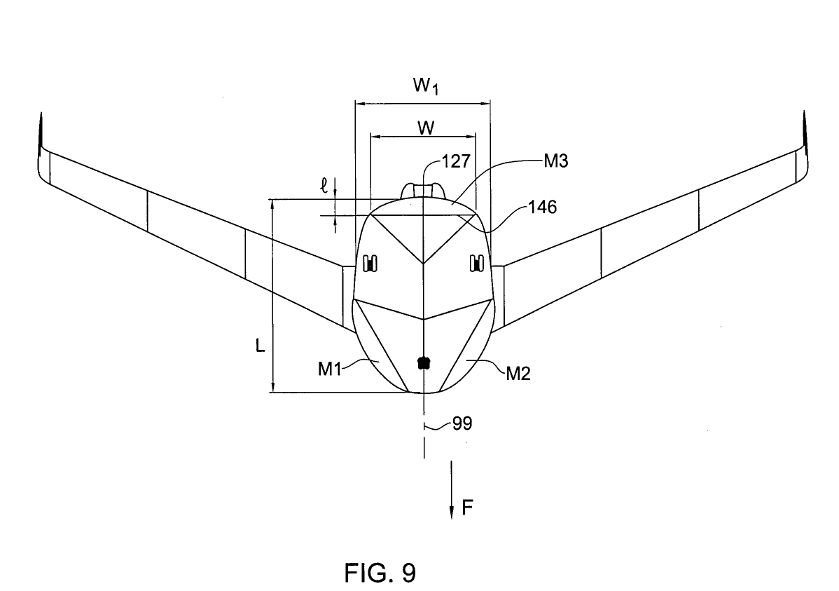

As best seen in FIGS. 8 and 9, the fuselage 120 is non-axisymmetric, and comprises a generally oval planform, comprising a forward portion 121, and an aft portion 126. The forward portion 121 has a streamlined shape, and the aft portion 126 is blunt and lacks an ogive surface or profile. The forward portion has a forward end or nose 123 and further including port side 122 and starboard side 124, and the aft portion 126 includes aft end 127. The air vehicle 100 also has a longitudinal centerline or longitudinal axis 99 passing through fuselage 120 in the general direction F of forward flight of the air vehicle 100. The longitudinal axis 99 thus defines the z-axis or roll axis of the air vehicle 100, and the pitch axis (or x-axis) and the yaw axis (y-axis) are each orthogonal to one another and to the longitudinal axis 99. For convenience, the z-y plane may be referred to herein as the “vertical plane”, and the z-x plane may be referred to herein as the “horizontal plane”, which is parallel to one or more “azimuthal plane” referenced to the air vehicle 100, and the x-y plane may be referred to herein as a “transverse plane”.

Thus, the azimuthal reference plane of the air vehicle may be considered as being generally parallel to the horizontal plane of the vehicle and positioned at a real or imaginary center from which originate a plurality of lines of sight (LOS) associated with module system M. Some of these LOS are azimuthal lines of sight, aligned with the azimuthal reference plane, and some of these LOS are in elevation and thus intersect the azimuthal reference plane. In the illustrated embodiment, the azimuthal reference plane is aligned with the longitudinal axis 99, i.e., longitudinal axis 99 lies on the azimuthal reference plane.

The forward portion 121 extends from nose 123 to a transition section 125, and the aft portion 126 extends from transition section 125 to the aft end 127 of the fuselage. In the illustrated embodiment, the transition section 125 is an imaginary transverse plane between, and longitudinally dividing the fuselage 120 into, the forward portion 121 and the aft portion 126. Furthermore, for this embodiment, the longitudinal position of the transition section 125 is at the maximum width of the fuselage 120. Alternatively, and/or in the above or other alternative variations of this embodiment, the longitudinal position of the transition section 125 may be defined as being just aft of the trailing edges of the wings 160 at the wing roots 162. Alternatively, and/or in the above or other alternative variations of this embodiment, the transition section 125 may be positioned elsewhere, for example at a position along the axis 99 which is at a percentage TS of the fuselage length L from the nose 123, wherein TS is in the range of between about 75% and about 100%, or between about 50% and about 100%, for example.

Aft portion 126 has a generally closed configuration. In other words, at least a majority of the outer surface of the aft portion 126 has an absence of openings therein, or the whole aft portion 126 has an absence of any major openings. Such absent major openings may include, for example an exhaust nozzle arrangement of a propulsion system, such as a gas turbine propulsion system, bleed ports, and so on. In the above or other alternative variations of this embodiment, the aft portion may be divided into two, three or more transversely adjacent sections, having an opening, such as an engine exhaust nozzle, for example, between at least one pair of adjacent sections, and wherein each such section is otherwise closed.

The center of gravity of the air vehicle 100 is within the fuselage 120, in a suitable position relative to the center of lift generated by the wings 160 (and optionally the fuselage).

Wings 160 comprises port wing 160p and starboard wing 160s, which are essentially mirror images of one another, and are herein interchangeably referred to by the reference numeral 160. The wings 160 are configured for aerodynamically generating lift and providing directional stability to the air vehicle in forward flight, and in the illustrated embodiment, the fuselage 120 may also provide some lift as well.

Each wing 160 is swept back with a sweep angle of about 26 degrees, measured from an imaginary a line, quarter-chord between the wing tip 164 and the wing root 162. Each wing 160 has an aspect ratio of about 7.5, and comprises a vertical stabilizer in the form of winglet 165 at the respective tip 164. The wings 160 further comprise lift control devices, including one or more of ailerons, flaps, air brakes, leading edge slats, and so on (not shown in the Figures). In the illustrated embodiment, a plurality of ailerons are provided on the wings between the wing root 162 and the wing tip 162 for providing pitch, roll and yaw control. For example, deflection of one corresponding pair of ailerons (one in each wing) in the same direction provide pitch control, deflection of the ailerons in opposed direction provide roll control, and deflection of only one or the other aileron provides yaw control. For example, three sets of ailerons may be provided, three ailerons (one from each set) per wing spaced along the respective trailing edge, one pair dedicated to roll control, another pair to pitch control, and the third pair to yaw control. In variations of this embodiment, the winglets 165 may additionally or alternatively comprise rudders to provide at least yaw control. Of course, two or more such pairs of ailerons may be used for each of roll control, yaw control and/or pitch control.

In the illustrated embodiment, the wings 160 are different from the fuselage, and no part of the fuselage is formed as a leading edge of the wings 160.

In the illustrated embodiment, the wings 160 are fixedly attached to an upper portion of the fuselage 120 at the respective wing roots, such that a majority of the fuselage 120, and in particular the azimuthal plane, is vertically displaced in a downward direction (−y) from the wings, along axis y. In the above or other alternative variations of the embodiment, the wings may be swept forward and/or may be integrally joined to one another and fixedly connected to the fuselage, and/or the wings may be configured as variable geometry wings, providing optimal performance in various flight regimes, for example allowing the sweep to be changed between low speed and high speed flight.

The propulsion system 180 comprises two turbofan engines, each mounted in a respective nacelle 182, which are laterally mounted to one another in transverse spaced relationship via streamlined strut 184, which is in turn mounted on the dorsal surface 129 of the fuselage 120, via streamlined pylon 186 (see FIG. 7). The nacelles 182 each comprise an aft-extending fairing 183 provided for a lower part of the exhaust nozzles 188 of the engines opposite the dorsal surface 129.

In the above or other alternative variations of this embodiment, the propulsion system may comprise engines that are embedded in the fuselage, providing an integrated installation having inlets flush mounted with respect to the surface of the fuselage, for example, or alternatively the engine may be carried dorsally, above the wings.

In yet other alternative variations of this embodiment the air vehicle lacks a permanent propulsion system, and may be configured to operate as a glider, which for example may be dropped from a carrier aircraft or balloon, for example, and/or may optionally comprise a discardable temporary propulsion unit, for providing forward velocity and height to the air vehicle. Such a glider configuration may comprise a suitable controller to maintain a particular path, or alternatively may lack such a controller, and is allowed to freely descend while operating to provide the desired data as provided by the sensor modules—such an embodiment may also be configured for providing its position in real time, together with the sensor data, for example.

The air vehicle 100 further comprises a tricycle undercarriage arrangement 190, comprising a front landing gear strut 192 including a pair of nose wheels, and two main landing gear struts 194, 196, each including a pair of main wheels. In the illustrated embodiment, the undercarriage arrangement 190 is selectively retractable and deployable with respect to the fuselage 120, in particular with respect to respective undercarriage bays (not shown). In the above or other alternative variations of this embodiment the undercarriage arrangement 190 may be fixed, or alternatively at least some of the components of the undercarriage arrangement 190 may be selectively retractable and deployable with respect to other parts of the vehicle 100, for example the wings 160. In these or other variations of this embodiment, the wheeled undercarriage arrangement 190 may be replaced or supplemented with skis or pontoons, or with any other suitable landing system.

Optionally, the air vehicle 100 may be fitted with an emergency parachute for emergency landing, for example in case of engine failure.

In the above or other alternative variations of this embodiment, the fuselage 120 may optionally further comprise a deployable hook on the underside 128 of the fuselage 120, configured for engaging with an arrestor wire fixed to a landing strip, for example facilitating carrier operations, or for engaging with a suspended arrestor wire or net for capture of the air vehicle.

The air vehicle 100 further comprises suitable fuel tanks for providing fuel to the propulsion system, and a suitable navigation and control computer, including GPS capability or the like, for example, inertial sensors, and other sensors (speed sensors, height sensors, etc.) for determining the geographical location, altitude, attitude, velocity and acceleration vectors of the vehicle in real time, and for controlling the flight path of the vehicle. In the illustrated embodiment the vehicle 100 is a UAV, and may further comprise further surveillance or observation equipment such as for example cameras and the like, for example in the bulged upper section 195 of the fuselage 120 (FIG. 7) and/or the underside of the fuselage. In the above or other alternative variations of this embodiment, where the air vehicle is manned, the bulged section 195 may be replaced with a cockpit and canopy for accommodating a pilot or flight crew, for example.

Optionally, the air vehicle 100 may comprise a permanent or a detachable external stores arrangement or other additional payload mounted to the underside of the fuselage, for example in the form of a gondola or a pod. Such an additional payload may comprise, for example, additional sensors and/or emitters.

The air vehicle 100 may further optionally comprise a refueling probe for enabling in-flight refueling, thereby enabling non-stop operation of the vehicle as desired or until repairs or maintenance or damage requires the vehicle to be landed.

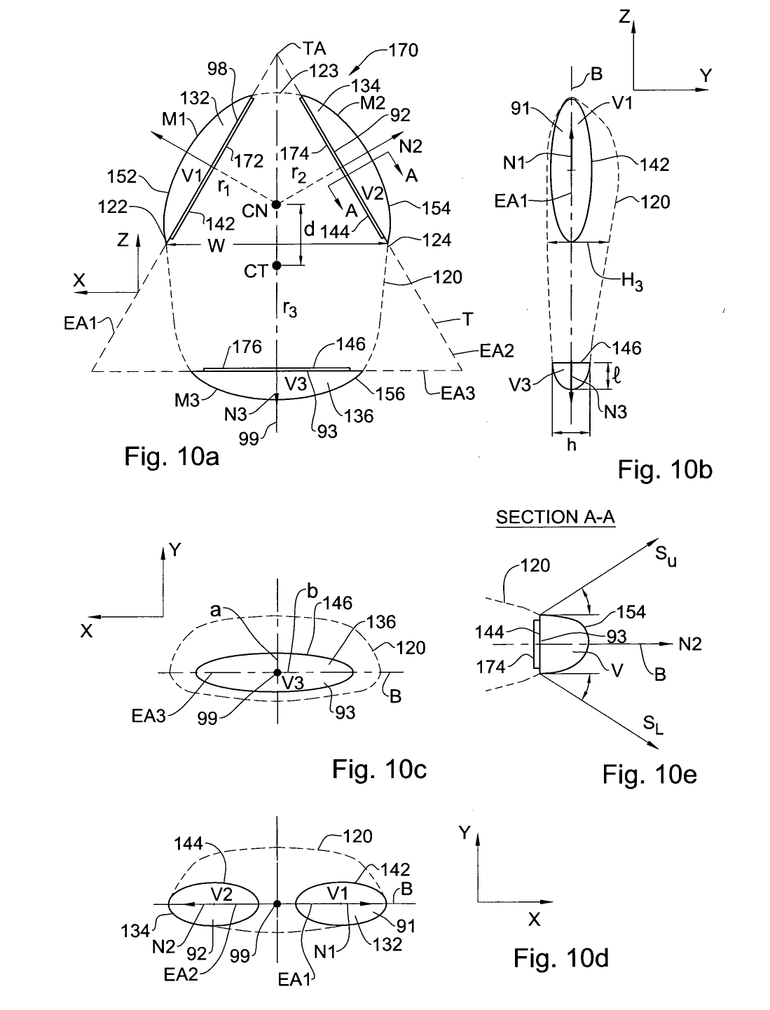

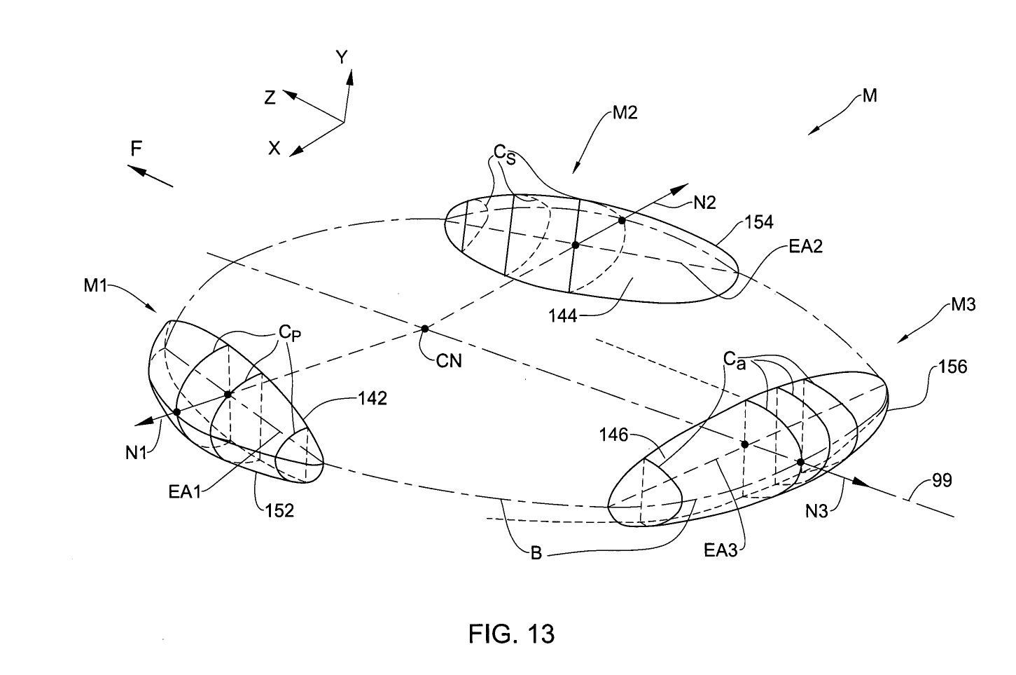

Referring in particular to FIGS. 13 and FIGS. 10a to 10d, sensor/emitter module system M comprises three sensor/emitter modules, M1, M2, M3, each comprising a sensor/emitter arrangement configured for providing sensing data and/or for emitting energy along directions associated, i.e., along, at least with a plurality of different (non-parallel) lines of sight (LOS) in azimuth with respect to the fuselage 120.

In the illustrated embodiment, each sensor/emitter module, M1, M2, M3 is particularly configured as a radar transmitter/receiver, and each said sensor/emitter arrangement is in the form of an antenna 172, 174, 176, respectively, accommodated in a respective peripheral compartment 132, 134, 136, (also referred to herein as chambers) comprised in fuselage 120 in spaced relationship along an azimuthal periphery thereof. The fuselage 120 may further comprise a plurality of additional internal compartments, for example including a cargo compartment.

Each antenna 172, 174, 176 comprises a respective sensing/emitting face 91, 92, 93, respectively, via which energy is sensed and/or emitted during operation of the respective sensor/emitter module (FIGS. 10a to 10e). Each sensing/emitting face 91, 92, 93, is elongated with respect to a respective elongation axis EA1, EA2, EA3, respectively. Each compartment 132, 134, 136 is intersected by a common reference plane B (see also FIG. 7), and plane B in the illustrated embodiment is also an azimuthal plane preferably the azimuthal reference plane of the air vehicle, substantially parallel to the z-x plane and thus to the longitudinal axis 99.

In this embodiment (as well as in other alternative variations of this embodiment, and in other embodiments) the azimuthal reference plane of the air vehicle (plane B) intersects the fuselage 120.

In alternative variations of this embodiment, only compartments 132, 134 are intersected by common reference plane that is substantially parallel to the z-x plane, while in yet other variations of this embodiment there is no common reference plane that intersects any two or all three of compartments 132, 134, 136. In such cases, each compartment is considered to have its own (or partially shared) reference plane (typically parallel to the horizontals plane and intersecting the respective sensing/emitting face), and a “common” reference plane instead refers to an imaginary plane that is associated with and collectively represents the various reference planes of the individual compartments. In the above or other alternative variations of the embodiment, the reference plane may instead be inclined to the z-x plane, for example.

Compartments 132 and 134 are located in forward portion 121 (sides 122, 124, respectively), and compartment 136 is located in the aft portion 126. Each peripheral compartment 132, 134, 136 comprises a respective ground plane 142, 144, 146, and a respective radome structure in the form of generally rounded fairing 152, 154, 156, respectively, that extend outwardly from the respective ground plane 142, 144, 146, generally defining between each respective set of ground plane and fairing an internal volume, V1, V2, V3, respectively. The rounded fairings 152, 154, 156 form part of the sides 122, 124 and aft portion 126, respectively, and in particular the outer surface and outer skin of rounded fairings 152, 154, 156 constitute part of the outer surface and outer skin, respectively, of the fuselage 120. In the illustrated embodiment, the fairings 152, 154, 156 each have an external shape that resembles, is similar to, or is close to, the shape of a part of the external surface of an ellipsoid or superellipsoid, for example the external surface of half of an ellipsoid or of half of a superellipsoid.

In particular, each of the fairings 152, 154, 156 in the illustrated embodiment lack sharp edges or discontinuities in slope (such as kinks, for example), at least over a majority of the surface thereof, and/or at least in a central portion of the surface thereof, this central portion being over 50% of the outer surface of the respective fairing, for example. In any case the fairings 152, 154, 156 are made of a suitable electrically non-conductive materials that are substantially transparent to radar signals. For example, the fairings 152, 154, 156 may be made from resin-impregnated fiberglass or the like of sufficient thickness that is sufficiently strong to withstand the dynamic pressure in the flight envelope of the vehicle 100, and optionally also adverse weather conditions, for example ice, sleet, hail, sandstorms, and so on. Another example of a suitable material is a honeycomb sandwich comprising glass/epoxy skins and a Nomex honeycomb core, by Israel Aircraft Industries, Israel. Similarly, any supporting or other structure within the volumes V1, V2 and V3 are similarly constructed from such suitable non-conductive materials.

The ground planes 142, 144, 146 each define an imaginary normal N1, N2, N3, respectively, at the geometric center of the respective ground plane and extending in an outward direction toward the respective fairing 152, 154, 156, perpendicularly to the respective ground plane.

Each sensing/emitting face 91, 92, 93, is associated with a plurality of LOS of the sensor/emitter module system M, and these LOS intersect the respect face. In particular, each sensing/emitting face 91, 92, 93, has a plurality of azimuthal LOS that intersect that intersect the respect face thereof.

As best seen in FIG. 10a, the ground planes 142, 144, 146 (and correspondingly the elongation axes AE1, AE2, AE3, mutatis mutandis) are arranged, in plan view, in a general isosceles triangular arrangement, such that the ground planes 142 and 144 lie along a respective equal side of an imaginary isosceles triangle T and defining an apex TA therebetween, with ground plane 146 lying on the base side of the imaginary isosceles triangle T, opposite this apex TA. In particular, the isosceles triangle arrangement is an equilateral triangle arrangement, the imaginary isosceles triangle T being an equilateral triangle, and thus, in plan view, each ground plane is inclined at an angle of 60 degrees with respect to each of the two adjacent ground planes, and thus apex TA is also 60 degrees. In the above or other alternative variations of this embodiment, any suitable isosceles triangle arrangement T may be provided, with the apex TA being greater than, or alternatively less than, 60 degrees. Thus, ground planes 142 and 144 each face the forward direction and respectively towards the port and starboard sides, while ground plane 146 faces the aft direction.

Thus, the normal N1 faces a direction generally inbetween the forward direction (+z), the port direction (+x), and normal N2 faces a direction generally inbetween the forward direction (+z), the starboard direction (−x), and the ground plane 146 faces generally in the aft direction such that normal N3 is pointed in the general aft direction (−z).

In other words, two of the three sensor/emitter arrays are arranged with the respective sensing/emitting face 91, 92 thereof partially facing a forward direction and along said longitudinal axis, and partially facing a respective side direction (port or starboard) along the pitch axis. The third sensor/emitter array is arranged with the respective sensing/emitting face 93 thereof partially facing the aft direction.

In particular, the normals N1 and N2 are +60 degrees and −60 degrees, respectively, from axis 99 along plane B. In the illustrated embodiment, plane B intersects the three ground planes 142, 144, 146 at the intersection of the respective normals N1, N2, N3 with the ground planes 142, 144, 146, and these normals thus lie on plane B.

In the above or other alternative variations of this embodiment, the ground planes 142, 144 may also be tilted slightly towards the general downwards direction, and thus that normal N1 faces a direction generally inbetween the forward direction (+z), the port direction (+x) and the downward direction (−y), and normal N2 faces a direction generally inbetween the forward direction (+z), the starboard direction (−x) and the downward direction (−y); additionally or alternatively, the ground plane 146 may also be tilted slightly towards the general downwards direction, and thus that normal N3 faces a direction generally inbetween the aft direction (−z), and the downward direction (−y).

In the embodiment of FIGS. 10a to 10d, and as also seen in FIGS. 6 and 7, each ground plane 142, 144, 146 is elongated along a direction parallel to or aligned with the respective elongation axis EA1, EA2, EA3, respectively, and has a generally elliptical shape or super-elliptical shape, with a respective major axis a and a respective minor axis b (see FIG. 10c). The aspect ratio a/b of the respective ground plane may be in the range between just over 1.0 to 10 or more, for example about 2.8. The major axes are associated with reference plane B (and the azimuthal plane), in the illustrated embodiment plane B intersecting the three major axes, and the major axes are associated with (and are parallel or aligned with) the respective elongation axes EA1, EA2, EA3.

The three antennas 172, 174, 176, are phased array antennas and are part of radar system 170 of vehicle 100, and each antenna is carried on a respective ground plane 142, 144, 146, each antenna having its respective face 91, 92, 93 facing outward from the triangle T. In particular faces 91 and 92 each face partially in the forward direction, and also partially a respective side direction (starboard and port respectively), while face 93 faces in a general aft direction.

Each said array antenna 172, 174, 176 is similarly shaped, and has the same aspect ratio as, the respective ground plane 142, 144, 146. Each said array antenna 172, 174, 176 comprises said sensing/emitting face, 91, 92, 93 respectively, in the form of a respective Active Electronically Scanned Array (AESA), including a plurality of array transmit/receive (T/R) modules, for example printed circuit dipoles, and allow a respective electromagnetic radar beam to be electronically steered. Each sensing/emitting face, 91, 92, 93 is planar in the illustrated embodiment, and is elongated with respect to an elongation axis corresponding to the respective major axis of the respective ground plane. In Alternative variations of this embodiment, the sensing/emitting faces of one or more sensing/emitting arrays may be non-planar.

The radar antennas 172, 174, 176 may have short to instantaneous scanning rates (e.g., in the millisecond range), and may have a low probability of being intercepted. Furthermore, the radar system 170 is optionally also configured for tracking and engaging a plurality of independent targets (multiple agile beams), and furthermore may be optionally configured for operating as a radio/jammer, and/or for providing simultaneous air and ground modes, and/or for operating as a Synthetic Aperture Radar (SAR).

The triangular arrangement of the three phased array antennas permit the same components, such as for example transmitter, radio frequency source, beam forming equipment, and other equipment, to be switched between the three antennas. This potentially reduces the number of components and space required for the components and also permits an irregular scanning rate or intermittent scanning of any azimuth as desired.

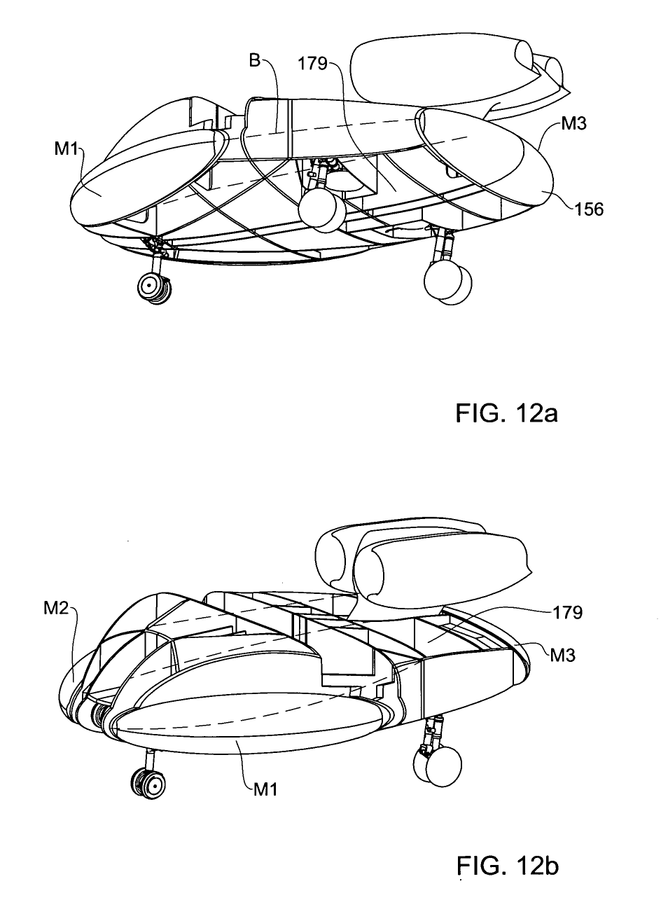

Such radar systems and AESA's are very well known in the art and will not be described further herein. Suitable electronic equipment and components for powering, generating and controlling the radar beams are accommodated within suitable bays or compartments within the fuselage 120. While such equipment and components are also well known, according to an aspect of the invention these are in modular form and are accommodated in internal bays or compartments 179 (see FIGS. 12(a) ad 12(b)), and are readily accessible via suitable access panels (not shown) on the outer surface of the fuselage 120, facilitating repair and replacement of the equipment and components, as required.

During operation of the radar system 170, the array antennas 172, 174, 176 each scan a 120 degree sector of an azimuth volume based on azimuth plane B, and may be electronically scanned in sequence to provide cyclic 360 degree scanning in azimuth. Each antenna is electronically scanned from side to side, with the scanning being limited to 60 degrees on either side of broadside of each antenna for this embodiment. The broadside direction is along the long axes b of the respective ground planes. Alternatively, the three array antennas 172, 174, 176 may be electronically scanned simultaneously to reduce the time to achieve a full 360 degree scan to a third, in which case each antenna may have a different operating frequency to avoid interfering with one another, for example as disclosed in US 2008/0191927, assigned to the present Assignee, and the contents of which are incorporated in full. In one non-limiting example, all three array antennas 172, 174, 176 operate in the L-band. In the above or other alternative variations of this embodiment, the radar system may be configured for operating, for example, at electromagnetic wavelengths at least in the X band or greater, or in the S-band.

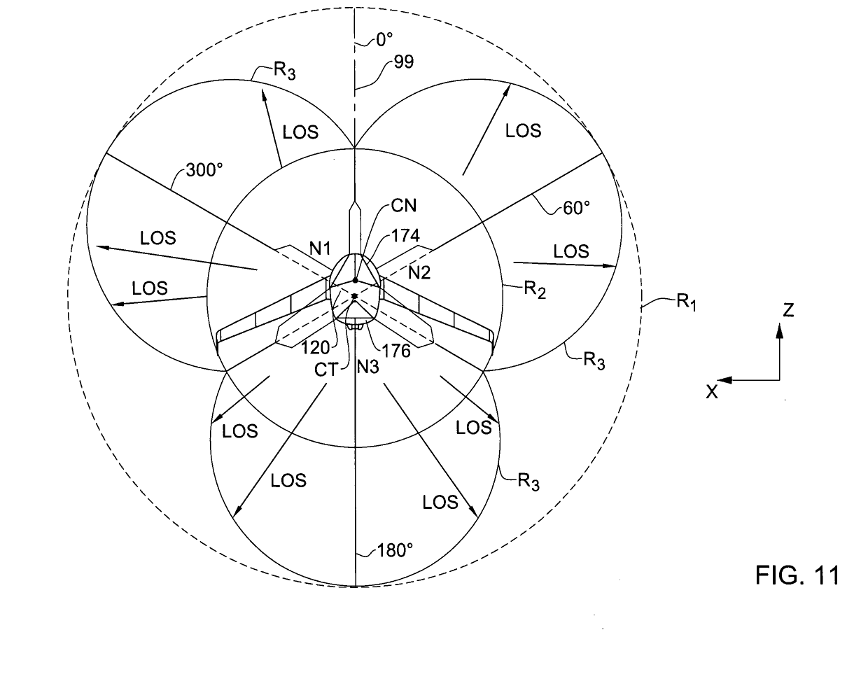

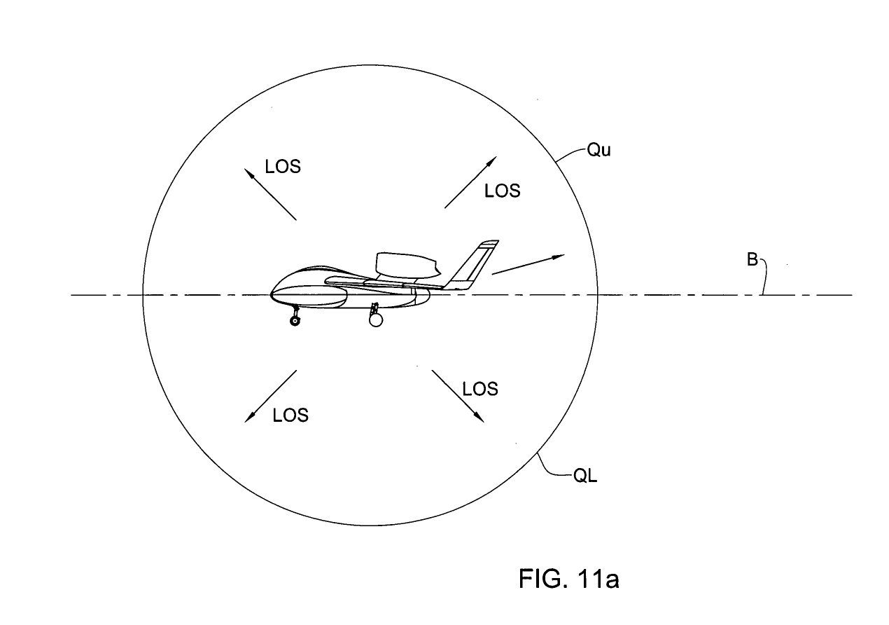

Referring in particular to FIG. 11, in the illustrated embodiment the maximum range R₁ for radar coverage in azimuth is obtained at the center of each array antenna 172, 174, 176, and the range in the broadside direction, illustrated by the lobes indicated at R₃; varies in proportion to the cosine of the scanning angle between the radar beam and the broadside, so that at the extremities of each array antenna 172, 174, 176, where the beam is at 60 degrees to broadside, range R₂ is obtained, wherein:

R₂=0.5*R₁

Thus, antenna 172 covers a sector 0 degrees to 120 degrees, antenna 176 covers a sector 120 degrees to 240 degrees, and antenna 174 covers a sector 240 degrees to 360 degrees, in azimuth, wherein the datum 0 degrees and 360 degrees is in the z-direction along longitudinal axis 99.

In alternative variations of this embodiment, a different radar coverage may be provided, for example having nominally uniform range with respect to the center of the air vehicle.

Referring to FIG. 10e, antenna 174 has a field of view in elevation bounded by directions Sᵤ and Sᵢ, about ±60 degrees with respect to plane B (respectively above and below plane B). Similarly, mutatis mutandis, antennas 172 and 176 also each have fields of view of about ±60 degrees with respect to plane B, respectively above and below plane B, in elevation. Alternatively, each field of view for the antennas may be about ±40 degrees with respect to plane B. Alternatively, each field of view for the antennas may be asymmetric with respect to plane B—for example, there may be a greater field of view below plane B, say −30 degrees, than above plane B, say about +15 degrees.

In alternative variations of this embodiment, full look down capability may be provided by installing a suitable antenna array on the underside of the fuselage, directly, or indirectly via a suitable pod or gondola that is mounted to the underside of the fuselage.

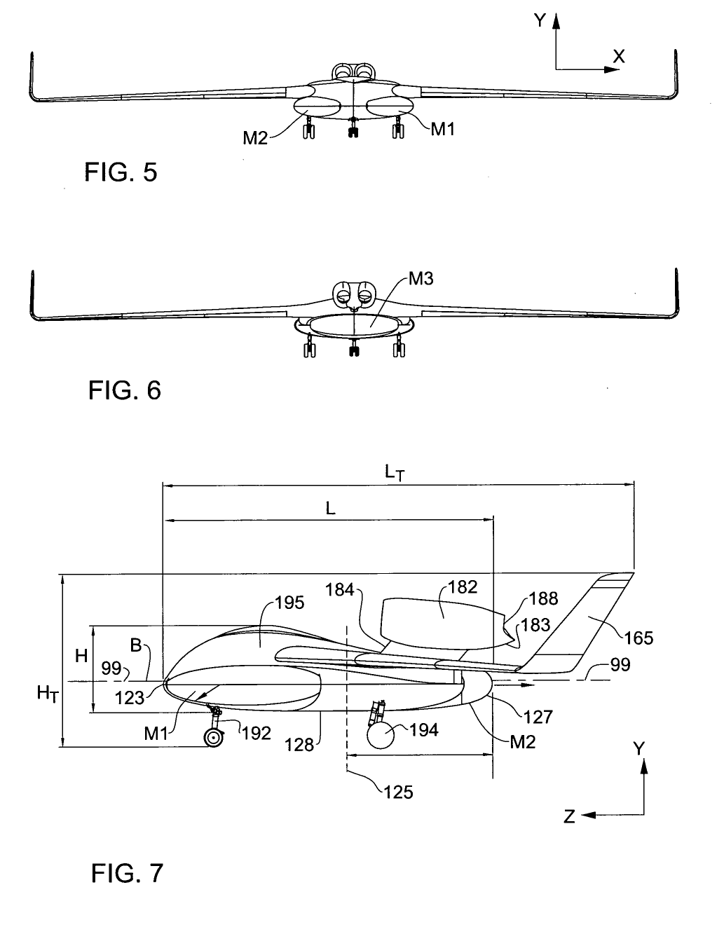

As may be seen from FIGS. 5, 6 and 7 in particular, the is no part of the air vehicle 100, in particular of the wings 160 or of the propulsion system 180, that is in the line of sight of the array antenna 172, 174, 176 in azimuth at plane B, or in elevation below the plane B for the full 360 azimuth i.e., with respect to an imaginary lower hemisphere QL (FIG. 11a), other than, of course, the respective fairings 152, 154, 156. Thus, the configuration of vehicle 100 allows full panoramic field of view in azimuth at plane B and at elevations below plane B.

Furthermore, there is also a virtually unobstructed line of sight of the array antennas 172, 174, 176 in elevation above the plane B (again, other than the respective fairings 152, 154, 156) i.e., with respect to an imaginary upper hemisphere QT (FIG. 11a). Referring to FIG. 9 in particular, it is evident that the wings 160, which are potentially the source of maximum interference above plane B, are aligned with the minimum ranges of the aft broadsides of array antennas 172, 174, to minimize such interference. Thus interference at the maximum range points of the antenna ranges is reduced to a minimum for elevation angles above the plane B.

Thus, the wings 120 are located above plane B to minimize or to fully avoid interfering with the operation of radar system 170 at least in azimuth at zero and downward elevations (with respect to plane B). While in the illustrated embodiment, the wings 160 have no dihedral or anhedral, in variations of this embodiment in which the wings have dihedral or anhedral, it is still ensured that no part of the wings intersects plane B, or minimally interferes with the operation of the radar system 170.

Referring to FIG. 10a in particular, it is to be noted that the intersection point CN of the normals N1, N2, N3, projected in an inwards direction into the fuselage 120, lies on the vertical z-y plane, On (or, in alternative variations of this embodiment, vertically displaced with respect to) the longitudinal axis 99, but this point CN is displaced forwards of the center CT of imaginary triangle T by spacing d. Referring to FIG. 11, ranges R₁ and R₂ are referenced to the center CT, rather than point CN. However, since the magnitudes of the ranges R₁ and R₂ are considered to be much higher, typically orders of magnitude higher than the magnitude of spacing d, the displacement d of point CN from center CT does not in practical terms affect the azimuthal cover offered by the three array antennas 172, 174, 176. For example, spacing d may be in the order of fractions of a meter, or in the order of meters or tens of meters, while the ranges R₁ and R₂ may be in the order of kilometers, tens or kilometers, or hundreds of kilometers, or greater, for example.

As clearly evident from FIG. 11, the sensor module system is configured with three generally similar sensor modules M1, M2, M3, peripherally distributed around the fuselage in an azimuthal direction, to provide a sensor range, which at least in azimuth has generally rotational symmetry as well as multiple symmetrical axes, with respect to CT, and effectively so with respect to CN. In alternative variations of this embodiment, the sensor modules may differ from one another.

Thus, the radar system 170 is configured for emitting and sensing electromagnetic energy at radar wavelengths, and is capable of detecting a target at a long range distance, for example more than 50 km, by sensing radar signals returned from the target.

The air vehicle 100 further comprises suitable means for at least one of further processing, encryption, storage and/or transmittal of the radar data acquired by means of the radar system 170, using suitable equipment.

In the illustrated embodiment, or in the above or other alternative variations of this embodiment, the radar system may be additionally or alternatively configured as an electromagnetic energy emitting unit, and may comprise a radar jammer arrangement, for example and thus is configured for emitting electromagnetic energy in the form of a radar jamming signal. In yet other alternative variations of this embodiment, at least one sensing module comprises a passive radar detector, for example any suitable SIGINT module for intercepting signals, optionally including at least one of an ELINT module and a COMINT module, for example for detecting the existence and location of a target radar.

In at least some alternative variations of this embodiment, at least one sensing module comprises any suitable passive radar means which is configured for receiving radar signals from a target, which for example may be illuminated by a different source.

In at least some alternative variations of this embodiment, at least one sensing module comprises other transmitting and/or sensing means, such as for example an antenna such as a guard antenna, and/or IFF (identify friend or foe) elements such as for example dipoles and so on, and/or radio transmitting elements as may be used, for example, for transmitting control signals to a vehicle or installation that may be homed onto via the radar system.

In the above or other alternative variations of this embodiment, the radar system may instead comprise a passive electronically scanned array (PESA), including a phased array on each ground plane 142, 144, 146, and a central radiofrequency source (such as for example a magnetron, a klystron or a traveling wave tube), for providing energy to phase shift modules, which then send energy into the various emitting elements in the respective antennae. In the above or other alternative variations of this embodiment, the radar arrangement may instead comprise a Synthetic Aperture Radar (SAR).

In the above or other alternative variations of this embodiment, at least one sensor/emitter module comprises an electro-optic scanner arrangement, including any suitable type of light-sensitive sensor, and may have one or more electro-optical devices that may be optically coupled to provide a corresponding portion of the panoramic 360 degree field of view in azimuth, as well as a desired field of view in elevation. The electro-optic scanner arrangement may be generally configured for procuring optical images in electronic/digital form, for further processing, storage and/or transmittal via suitable equipment. These images may be still images (frames) and/or video images, and the sensor/emitter module(s) may be configured for providing such images in the visible electromagnetic spectrum, and/or in the non-visible spectrum, for example infra red and/or ultraviolet, and/or multi/hyper-spectral. Additionally or alternatively, one or more sensor/emitter modules may be configured for night vision and/or for thermal imaging. Additionally or alternatively, the or each sensor/emitter module may be configured for capturing the images on photographic film, which can be retrieved for processing at a convenient time, for example after recovery of the vehicle 100, or by suitably ejecting the film, for example enclosed in a capsule, by means of a suitable arrangement, as is known in the art.

Additionally or alternatively, the or each sensor/emitter module may be configured for emitting energy and comprises a pulsed laser designator for finding a range and marking a target, for example, and/or comprises means for providing an active illumination.

Additionally or alternatively, the or each sensor/emitter module may be configured for emitting energy and/or sensing energy, and comprises one or more of: SIGINT sensors, stand-off electronic warfare systems, communication systems, and so on.

In the above or other alternative variations of this embodiment, the array antennas 172, 174, 176 may be replaced with any other suitable sensors and/or transmitters, each having a respective elongated sensing/emitting face, and suitably accommodated in chambers 132, 134, 136, respectively, which may comprise a different configuration to that described above, mutatis mutandis, as required.

In such variations of the embodiment in which a ground plane per se is not required, there may be defined a corresponding reference plane or bulkhead, for example.

In the above or other alternative variations of this embodiment, rather than having a common plane B intersecting the three sensor/emitter modules, each sensor/emitter module comprises its respective local reference plane, which may be defined as a plane passing through the center of the respective ground plane, and parallel to the azimuthal reference plane of the air vehicle or alternatively substantially normal to the respective ground plane. The sensor/emitter module having such a local reference plane may be regarded as having one or more features of the sensor/emitter module having common plane B as disclosed herein, mutatis mutandis.

As has been mentioned above, fairings 152, 154, 156 are rounded, in outward direction away from the respective ground plane. Referring to FIG. 13, each fairing 152, 154, 156 has a generally rounded cross-section Cₚ, Cₛ, Cₐ, respectively, in at least a majority of respective generally parallel planes, these planes being respectively orthogonal to the reference plane B and parallel to the respective normal N1, N2, N3. By way of example, the cross-sections Cₚ, Cₛ, Cₐ may have any suitable curved profile, for example circular (a sector of a circle, for example a semi circle), elliptical (a part of an ellipse, for example half an ellipse), superelliptical (a part of a superellipse, for example half a superellipse) a parabola, a hyperbola, any non-straight curve and lacking a discontinuity, and so on. The curved profile for each of the cross-sections Cₚ, Cₛ, Cₐ is thus configured to provide minimum interference with the emitted and received radar beams of the respective array antenna. In particular, in this and other embodiments, cross-sections Cₚ, Cₛ, Cₐ lack, particularly in the vicinity of plane B, any discontinuities, sharp corners and edges, and the like, especially such as resembling the streamlined trailing edge of wings for example. The corresponding profiles for the cross-sections Cₚ, Cₛ, Cₐ may be similar to one another, though in alternative variations of this embodiment they may differ from one another.

Forward and side facing fairings 152 and 154 are located generally at the leading end, i.e., forward portion 121 of the fuselage, and thus the rounded profile of these fairings can provide a favorable pressure gradient to the airflow over these fairings. On the other hand, aft fairing 156 is located at the trailing end of the fuselage 120, and provides the fuselage 120 with a generally blunt aft end (aerodynamically), i.e., a non-streamlined aft end, which minimizes or eliminates interference with the passage of radar beams therethrough. In accordance with some embodiments of the invention including this embodiment, the aft fairing 156, while providing this feature with respect to operation of the respective array antenna, results in an otherwise undesired drag penalty as compared with a streamlined aft-fuselage shape of the same general transverse cross-sectional profile and area. Thus, the aft portion 126, in side view, rapidly bends upwardly from the lower surface of the fuselage and downwardly from the upper surface of the fuselage, i.e., the slope of the aft fuselage changes abruptly, to provide a blunt end profile.

According to an aspect of the invention, the fuselage 120 may be considered purpose-designed to provide an unobstructed panoramic field of view of 360 degrees in azimuth for radar (referred to herein as an “azimuth volume”), with unobstructed look-down capability as well (i.e., also having substantial field of view in elevation, at least below the plane B), and essentially provides an integrated radome structure with the fuselage 120, incorporating the sensor modules in the original air vehicle airframe. As has been described above, in the illustrated embodiment the radar system 170 comprises three array antennas 172, 174, 176 arranged along the sides of an equilateral (or isosceles) triangle T. According to this aspect of the invention, the antennas 172, 174, 176 are placed close to one another such that the intersection point CN is close to (or in variations of this embodiment may be at) the center CT of triangle T, and the fuselage 120 is formed having a relatively modest first fineness ratio FR₁, defined herein as the ratio (L/W₁) between the longitudinal length L of the fuselage 120 to a reference width W₁ of the fuselage 120. Unless otherwise specified, the fuselage width W₁, taken along a direction parallel to the x-axis, is taken herein as the maximum width of the fuselage 120 at the reference plane B (FIG. 9) for this embodiment, though instead may be defined in different terms, for example the average or median width along the longitudinal length, or the maximum width of the fuselage. In the illustrated embodiment, the first fineness ratio FR₁ is between about 1.375 and about 1.5, based on the aforesaid maximum width of the fuselage 120 at plane B.

According to this aspect of the invention, fuselage 120 is formed having a relatively modest second fineness ratio FR₂, defined herein as the ratio (L/H₂) between the longitudinal length L of the fuselage 120 to a reference height H₂ of the fuselage 120, and/or having a relatively large inverse oblateness ratio (also referred to herein as a third fineness ratio) FR₃, defined herein as the ratio (W₁/H₃) between the aforementioned width W₁ of the fuselage 120 to the same or different reference height H₃ of the fuselage 120.

Unless otherwise specified, the height H₂ and/or height will be taken herein as maximum height H of the fuselage 120 (FIG. 7), the average or median height along the longitudinal length, or the height at the transition plane 125 (which itself may be located at any desired position, including at a position corresponding to the maximum height, for example), or the height at the maximum width of the fuselage, and on.

In the illustrated embodiment, the reference height H₂ for second fineness ratio FR₂, is the maximum height H of the fuselage 120, and the overall second fineness ratio FR₂ is about 3.7. In the illustrated embodiment, the reference height H₃ for third fineness ratio FR₃ is based on the maximum height H₃ at the plane of the maximum width W (se FIGS. 10a and 10b), and the inverse oblateness ratio FR₃ is about 3.2.

An alternative second fineness ratio, based on length L and the maximum height h of the aft sensor module M3, has a value of about 7.3 for this embodiment. Another alternative second fineness ratio, based on length L and the height H₃ of the fuselage 120 at maximum width W thereof on plane B, has a value of about 4.4 for this embodiment.

In variations of this embodiment and in other embodiments, the first fineness ratio FR₁, referenced to the longitudinal length and a reference width, such as for example the maximum width at a reference azimuthal plane (or alternatively at another reference plane) intersecting at least one sensor module, may be less than or equal to at least one of the following ratios: 0.8; 1.0; 1.5, 2.0, 2.5, 3.0, 3.5, 4.0, 4.5, 5.0; or any other ratio inbetween the aforesaid ratios.

In the above or other alternative variations of this embodiment, and in other embodiments, the second fineness ratio, referenced to the longitudinal length and a maximum height of the fuselage, may have a value less than at least one of the following ratios: 6; 5; 4; 3; 2; 1 or any other ratio inbetween the aforesaid ratios.

In the above or other alternative variations of this embodiment, and in other embodiments, the second fineness ratio, referenced to the longitudinal length of the vehicle fuselage and a maximum height of an aft portion of the air vehicle fuselage, i.e., not including any empennage or wing structures, may have a value less than at least one of the following ratios: 10, 9, 8, 7, 6; 5; 4; 3; 2; 1 or any other ratio inbetween the aforesaid ratios.

In the above or other alternative variations of this embodiment, and in other embodiments, the second fineness ratio, referenced to the longitudinal length of the vehicle fuselage and a height of the vehicle fuselage at its maximum width on the reference plane, may have a value less than at least one of the following ratios: 8, 7, 6; 5; 4; 3; 2; 1; or any other ratio inbetween the aforesaid ratios.

In the above or other alternative variations of this embodiment, and in other embodiments, the third fineness ratio or inverse oblateness ratio, referenced to the a maximum height of the fuselage at the reference plane, and the maximum height of the fuselage at this maximum width, may have a value greater than at least one of the following ratios: 10, 9, 8, 7, 6; 5; 4; 3; 2; 1.5, 1 or any other ratio inbetween the aforesaid ratios.

Referring to FIG. 9, it is also possible to define a local first fineness ratio, LFR₁, for the aft portion 126 and/or for the aft sensor module M3, as the ratio (l/w) between the longitudinal length l of the sensor module M3, i.e., the longitudinal spacing between the trailing end thereof (which is also end 127) and the respective ground plane 146, and the width w of the sensor module M3 (i.e., 2*b—see FIG. 10c). In the illustrated embodiment, the overall first local fineness ratio LFR₁ is about 0.35, based on the aforesaid maximum width. In some alternative variations of this embodiment, and in other embodiments, the first local fineness ratio LFR₁, referenced to the longitudinal length and width of an aft sensor module, or alternatively of an aft portion of the air vehicle fuselage, i.e., not including any empennage or wing structures, may have a value less than at least one of the following ratios: 1.0; 0.9; 0.8; 0.7; 0.6; 0.5; 0.4; 0.3; 0.15; or any other ratio inbetween the aforesaid ratios.

Furthermore, according to this aspect of the invention, the field of view of the antennas 172, 174, 176 in elevation, is a function of a characteristic height of the antennas 172, 174, 176. Similarly, the power output of the antennas, and/or range and/or resolution of the antennas, are a function of the plan area and thus of a characteristic height of the sensing/emitting faces of the antennas 172, 174, 176. In turn, this characteristic height is directly related to the height of the respective ground planes 142, 144, 146, which in the illustrated embodiment peaks at the center thereof (2*a—see FIG. 10c), and diminishes to zero at the broadsides, and may be defined as the maximum height of the respective ground plane, though in alternative variations of the embodiment may be defined in other ways, for example the mean height or the median height of the respective ground plane.

Referring to FIG. 10b, it is also possible to define a local second fineness ratio, LFR₂, for the aft sensor module M3, as the ratio (l/h) between the longitudinal length l of the sensor module M3, i.e., the longitudinal spacing between the trailing end thereof (which is also end 127) and the respective ground plane 146, and the height h of the sensor module M3 (i.e., 2*a—see FIG. 10c). In the illustrated embodiment, the second local fineness ratio LFR₂ is about 0.8.

Referring to FIG. 10c, it is also possible to define a local third fineness ratio or inverse oblateness ratio, LFR₃, for the aft sensor module M3, as the ratio (w/h) between the width w and the height h of the sensor module M3. In the illustrated embodiment, the local inverse oblateness ratio LFR₃ is between about 2.9 and about 4.2.

In the above or other alternative variations of this embodiment, and in other embodiments, the second local fineness ratio LFR₂, referenced to the longitudinal length and width of an aft sensor/emitter module, or of an aft portion of the air vehicle fuselage or fuselage, i.e., not including any tail or wing structures, may have a value less than at least one of the following ratios: 2.0; 1.9; 1.8; 1.7; 1.6; 1.5; 1.4; 1.3; 1.2; 1.1; 1.0; 0.9; 0.8; 0.7; 0.6; 0.5; or any other ratio inbetween the aforesaid ratios.

In the above or other alternative variations of this embodiment, and in other embodiments, the local inverse oblateness ratio LFR₃, referenced to the width and height of an aft sensor module, or of an aft portion of the air vehicle fuselage or fuselage, i.e., not including any empennage or wing structures, may have a value greater than at least one of the following ratios: 9, 8, 7, 6; 5; 4; 3; 2; 1 or any other ratio inbetween the aforesaid ratios.

Thus, and with reference also to the above disclosure regarding FIG. 13, it is evident that the fuselage 120 has vertical cross-sections along a plurality of planes parallel to the general direction of flight P, i.e. parallel to the z-y plane, in which the profile of the aft portion 126 for at least a majority of these cross-sections is relatively rounded, providing the aft portion 126 with aerodynamic characteristics associated with blunt aft bodies. Similarly, the fuselage 120 has transverse cross-sections along planes orthogonal to the direction of flight P, i.e. parallel to the y-x plane, in which the profile of the fuselage for at least a majority of these cross-sections at least aft of a longitudinal mid-section of the fuselage, or of aft portion 126, is relatively oblate.

In the air vehicle according to the illustrated embodiment, and in at least some alternative variations of this embodiment, the fuselage comprises cross-sections at planes corresponding to the locations of the respective array antennas (or other sensor/emitter arrays), in which a majority of each such cross-section is occupied by the respective said array. The fuselage also has a profile that is generally determined by the size, shape and locations of the array antennas (or other sensor/emitter arrays).

Referring again to FIG. 10a, each array antenna 172, 174, 176 is arranged in the fuselage around center point CN, wherein array antennas 172, 174, 176 are spaced from the center point CN by respective spacings r1, r2, r3 (taken in a direction parallel to the respective normals) which are dimensionally similar to one another, i.e., are generally in the same order of magnitude. In this and other embodiments, at least some of these spacings are not equal to one another for example spacing r3 represents a maximum spacing greater than spacing r1 or r2, which represent a minimum spacing for the illustrated embodiment, in which the maximum spacing r1 is larger than the minimum spacing r3 by less than a factor of 3 times the minimum spacing, i.e., r3/r1<3, and, r3/r2<3. The spacing ratio of the maximum spacing to the minimum spacing may be, in alternative variation of this embodiment and in other embodiments, less than any one of: 2, 4, 5, 6, 7, 8, 9 or 10, for example.

It is to be noted that in the illustrated embodiment the three antennas 172, 174, 176 are substantially similar in size, shape and in functionality, which facilitates logistics and manufacture, and furthermore have a modular construction, facilitating removal and replacement of the antennas. However, the three array antennas may instead be of dissimilar size and/or shape and/or functionality in the above or other alternative variations of this embodiment. For example, in one such variation of the embodiment, the aft antenna array 176 may be more powerful than the front antennas 172, 174, providing greater range in the aft direction. In another such variation of the embodiment, the aft antenna array 176 may be less powerful than the front antennas 172, 174, providing greater range in the forward and side directions than aft. In yet another variation of the embodiment, one of the front antennas, 172, for example, may be more powerful than the other front antennas 174 or aft antenna 176, providing greater range in the respective side directions than the other side direction or aft.

In the above or other alternative variations of this embodiment, and in other embodiments, the air vehicle may be provided with stores, including for example fuel tanks, sensor pods, etc, which may carried and optionally deployed from internal compartments in the fuselage. Alternatively the stores may be external stores, carried and optionally deployed from the fuselage or wings, preferably on the upper surfaces of the vehicle, but not in the line of sight of the antenna, particularly in azimuth, or are located and/or configured at least such as to minimize or avoid line of sight interference with the operation of the sensor modules, particularly avoiding intersection of the stores with plane B.

In the illustrated embodiment the vehicle 100 may be operated in a similar manner to many existing UAV's, inasmuch as the vehicle may be flown to a desired location or along a desired route, either by a user via remote control, or via preprogrammed instructions, or a combination of both. The vehicle according to at least the illustrated embodiment can operate as an AEW platform whenever desired by operating the radar system 170 to provide radar data in one or a plurality of lines of sight (LOS), typically continuously throughout the full 360 degrees panoramic field of view in the azimuth volume, i.e., along the reference azimuth plane and including elevations above and below the azimuth plane of the air vehicle. The radar data can be transmitted to the operator and/or to other locations directly, or indirectly via satellite or other suitable communications medium, for example by radio transmission, analog or digital. Additionally or alternatively, the radar data can be stored on board the air vehicle, and transmitted and/or retrieved at a later time with the air vehicle. Optionally, the radar data can be encrypted before transmission, and the vehicle 100 is suitably configured for doing so.

The air vehicle 100 may be configured for optimized loiter performance to maximize AEW operations over a desired theatre of operations, and for example the wings 160 are configured as high lift, large aspect ratio wings.

By way of non-limiting example, the illustrated embodiment of air vehicle 100 is provided with a maximum width W_{T} (wing tip to wing tip) of about 34 meters, a fuselage maximum width W of about 6.3 meters, fuselage length L of about 8.62 meters, an air vehicle maximum height H_{T} with the undercarriage deployed (winglet tip to wheels) of about 4.61 meters, and air vehicle maximum length L_{T} (nose to winglet tip) of about 12.3 meters (FIGS. 7 and 8).

It is to be noted that in plan view or in bottom view the wings 160 do not substantially overlap the modules M1, M2, M3, i.e., at least a majority of each said sensor/emitter array 172 174, 176 is free from superposition by the wings 160.

It is also to be noted that in variations of this embodiment, four, five, six, seven or more sensor/emitter modules may be provided, in appropriate arrangement, instead of three sensor/emitter modules, mutatis mutandis.

Alternative variations of this embodiment comprising alternative configurations in the sensor/emitter modules, operate in a similar manner to the illustrated embodiment, mutatis mutandis.

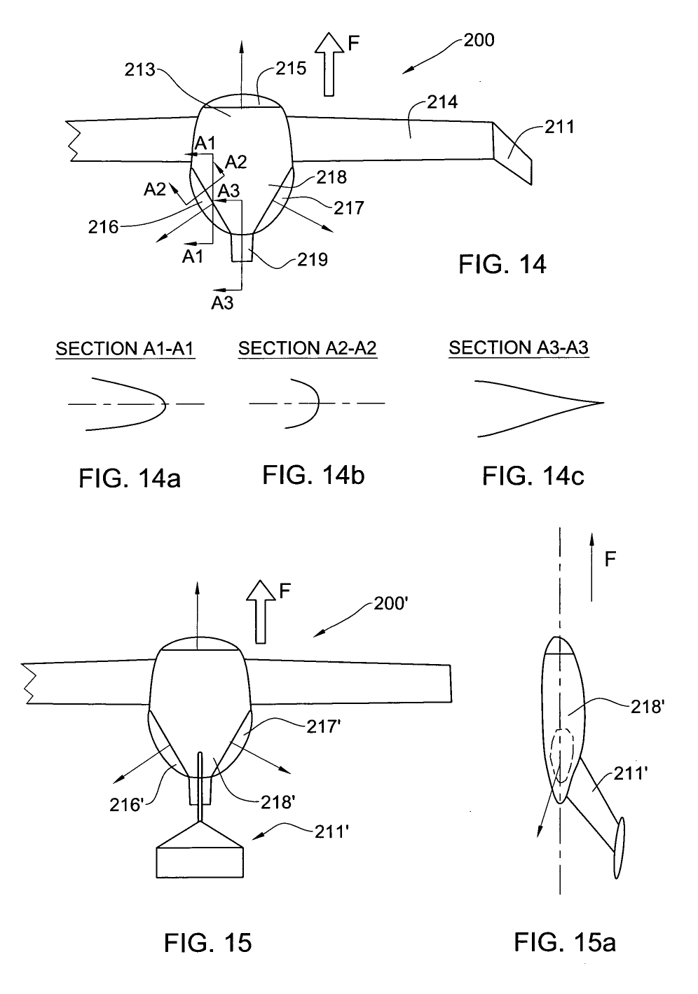

Referring to FIGS. 14 to 23, a number of additional embodiments of the air vehicle each have components, structure and features similar to those of the first embodiment or alternative variations thereof, as disclosed herein, mutatis mutandis, but each said additional embodiment having differences with respect to the first embodiment or alternative variations thereof, as follows.

The air vehicle according to a second embodiment of the invention, designated 200 and illustrated in FIGS. 14, 14a, 14b, 14c, comprises a fuselage 212 and wings 214 fixed thereto, including winglets 211, similar to the corresponding components of first embodiment or variations thereof, as described with respect thereto, mutatis mutandis. However, in the second embodiment, the fuselage 212 is essentially “back-to-front” with respect to the fuselage of the first embodiment, so as to accommodate the three sensor/emitter modules with one sensor module 215 facing directly forwards, and the remaining two sensor/emitter modules 216, 217 facing in the respective side direction and also in the aft direction. As may be seen, the aft end 218 is at least partially streamlined: the aft end 219, between the two modules 216, 217 can have a relatively sharp trailing edge, while the curvature of the fairings of the modules in the direction of flight F (FIG. 14a) are less “blunt” than the curvature of these fairings in planes orthogonal to the respective ground planes (FIG. 14b). Accordingly, the aft end 218 has aerodynamic advantages over the aft body of the first embodiment, and creates less drag. On the other hand, the relatively blunt front end 213 of the fuselage 212 may have a drag, control or performance disadvantage over that of the first embodiment.

A variation of the second embodiment, designated 200′ and illustrated in FIGS. 15 and 15a, has the same structure, features and advantages as described herein regarding the second embodiment, mutatis mutandis, with the main difference that instead of (or in addition to) winglets 211, the air vehicle 200′ comprises an empennage 211′ mounted to the aft end 218′. The empennage 211′ comprises a T-tail arrangement with horizontal stabilizers atop a single vertical stabilizer, and the empennage interferes minimally with operation of the sensor/emitter modules as is lies along the direction of minimum range between aft modules 216′ and 217′, i.e., the aft direction along the longitudinal axis.

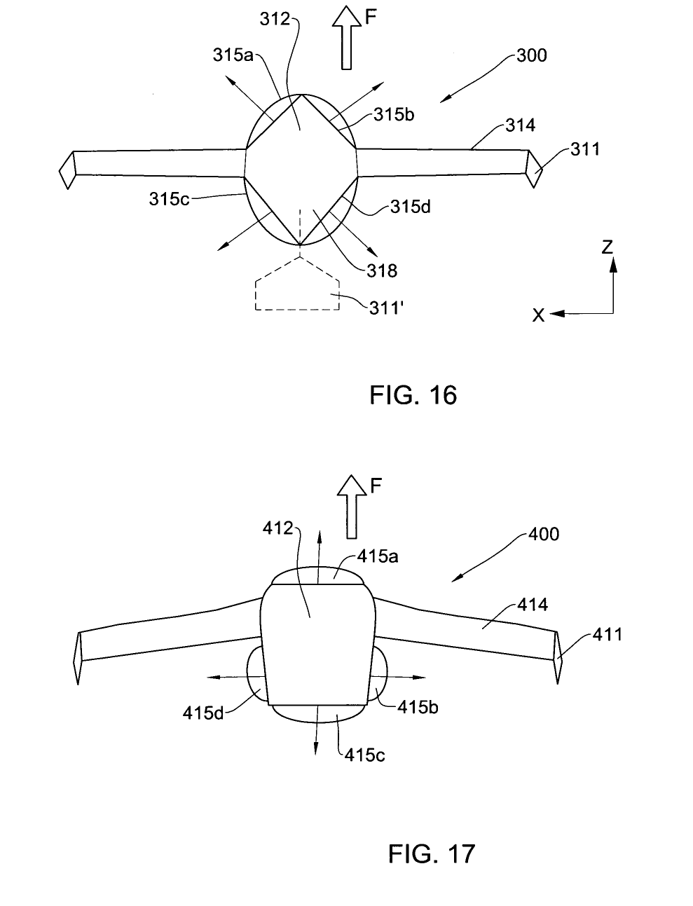

The air vehicle according to a third embodiment of the invention, designated 300 and illustrated in FIG. 16, comprises a fuselage 312 and wings 314 fixed thereto, including winglets 311, similar to the corresponding components of first or second embodiment or variations thereof, as described with respect thereto, mutatis mutandis. However, in the third embodiment, the fuselage 312 essentially combines the front end of the fuselage with respect to the fuselage of the first embodiment, with the aft end of the of the fuselage with respect to the fuselage of the second embodiment, so as to accommodate the four rather than three sensor/emitter modules. Thus, two sensor modules 315a, 315b are facing in the respective side direction and also in the forward direction, and the remaining two sensor/emitter modules 315c, 315d are facing in the respective side direction and also in the aft direction. As may be seen, the aft end 318 is at least partially streamlined as is the case with the second embodiment, mutatis mutandis, particular the portion 319 between the two modules 315c and 315d, and thus the aft end 318 has aerodynamically shape similar to that of the second embodiment, mutatis mutandis. At the same time, the fuselage 312 has a more streamlined front end with respect to that of the second embodiment. On the other hand, the third embodiment carries four sensor/emitter modules (in diamond-shape configuration in plan view, with the corresponding ground planes and normals being inclined to the longitudinal or z-axis and to the pitch or x-axis), which while possibly increasing the range in azimuth, may corresponding carry a weight and cost penalty as compared with the first or second embodiments. In a variation of the third embodiment, an empennage 311′ (shown dotted in FIG. 16) may be mounted to the aft end 318 instead of (or in addition to) winglets 311.

The wings 314 are fixed to the fuselage at a position inbetween the forward pair of modules 315a, 315b and the aft pair of modules 315c 315d, so that the wings do not substantially overlap the four sensor/emitter modules, i.e., at least a majority of the corresponding sensor/emitter array is free from superposition by the wings 314.

It is to be noted that the generally oval form (in plan view) and oblateness of the fuselage 312 allows the four sensor/emitter modules to provide wide coverage in the side direction as well as forward and aft, at the same time permitting the same type of sensor/emitters to be used in all the modules. Of course, in variations of the third embodiment, the sensor emitter modules may differ one from another, and each may be disposed at a desired angle with respect to the x and z axes.

The air vehicle according to a fourth embodiment of the invention, designated 400 and illustrated in FIG. 17, comprises a fuselage 412 and wings 414 fixed thereto, including winglets 411, similar to the corresponding components of third embodiment or variations thereof, as described with respect thereto, mutatis mutandis. However, in the fourth embodiment, the fuselage 412 is adapted for accommodating the four sensor/emitter modules 412a, 412b, 412c, 412d in rectangular arrangement (although in variations of this embodiment, the modules may be in trapezoidal arrangement mutatis mutandis), with sensor/emitter modules 412a, 412c facing directly forwards and aft, respectively, and sensor/emitter modules 412b, 412d facing starboard and port, respectively. The wings 414 are fixed to the fuselage at a position inbetween the forward module 415a and the middle pair of modules 415b, 415d, so that the wings do not substantially overlap the four sensor/emitter modules, i.e., at least a majority of the corresponding sensor/emitter array is free from superposition by the wings 414. Alternatively, the wings 414 may be fixed to the fuselage at a position inbetween the aft module 415c and the middle pair of modules 415b, 415d.

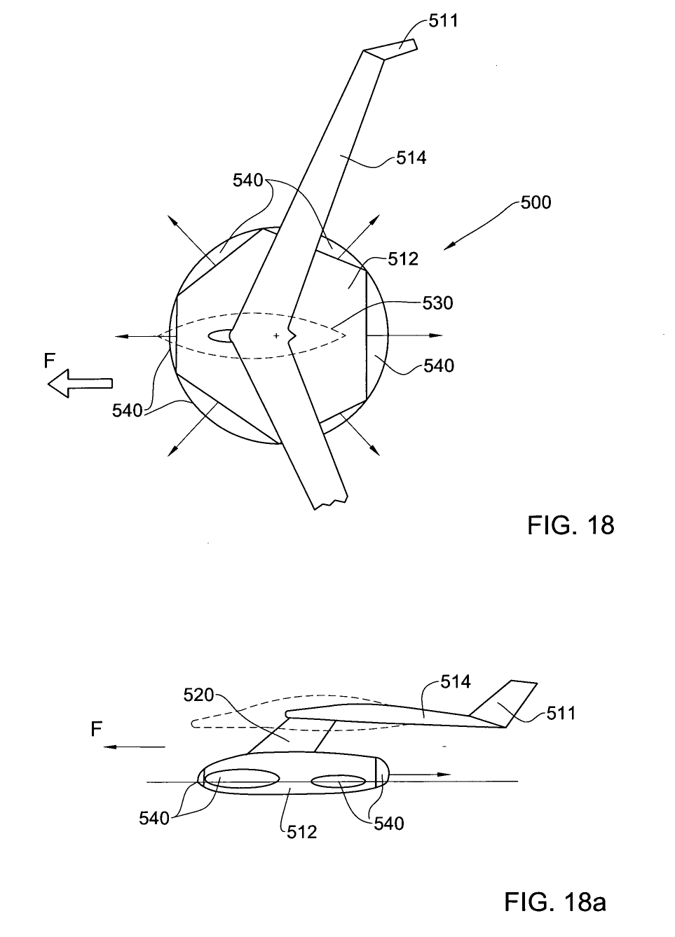

The air vehicle according to a fifth embodiment of the invention, designated 500 and illustrated in FIG. 18 and FIG. 18a, comprises a fuselage 512 and wings 514 (including winglets 511) in fixed wing relationship, similar to the corresponding components of first through fourth embodiments or variations thereof, as described with respect thereto, mutatis mutandis. However, in the fifth embodiment, wings 514 comprise an integral wing in flying wing configuration (though the wings may optionally comprise a central body fairing, as indicated at 530 in dotted line), and the fuselage 512 is fixedly attached to the wings 514 via pylon 520. The fuselage 512 is thus effectively suspended below the wings 514. In this embodiment, the fuselage 512 may have a generally axisymmetric shape in plan view, though in alternative variations of this embodiment, the fuselage may have a different shape, for example oval. The fuselage comprises six sensor/emitter modules 540, each one being similar to those described for the first through fourth embodiments, mutatis mutandis, but arrangement is general hexagonal arrangement. In variations of this embodiment, three, four, five, seven or more sensor emitter modules may be provided, in appropriate arrangement. In any case, the sensor/emitter modules may be similar in size and/or performance to one another, or at least some of the sensor/emitter modules may be different from the other sensor/emitter modules.

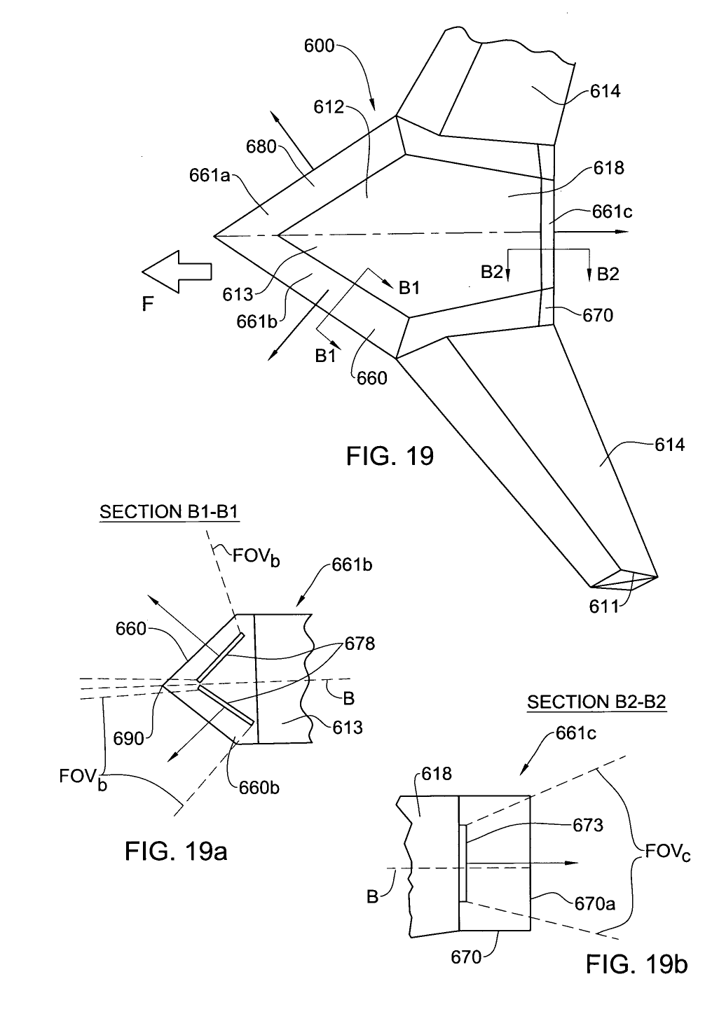

The air vehicle according to a sixth embodiment of the invention, designated 600 and illustrated in FIGS. 19, 19a, 19b, comprises a fuselage 612 and wings 614 fixed thereto, including winglets 611, similar to the corresponding components of first embodiment through the fifth embodiment or variations thereof, as described with respect thereto, mutatis mutandis. However, in the sixth embodiment, the fuselage 612 and the wings 614 are faceted, i.e., the outer skin has a faceted outer shape, rather than the smooth shape of the first embodiment through the fifth embodiment. In this embodiment, the fairings 680, 660 of the corresponding sensor/emitter modules 661a, 661b, and the fairing 670 of the corresponding sensor/emitter module 661c are not rounded, but rather also comprise faceted surfaces.

As best seen in FIG. 19b, sensor/emitter module 661c is aft-facing, and the corresponding fairing 670 is aerodynamically blunt, having a portion 670a thereof that is substantially planar and which encompasses the full field of view (FOV_{c}) of the sensor/emitter array 673, thereby interfering minimally with operation of the sensor/emitter array 673, and thus with the transmission of energy in either direction therethrough.

As best seen in FIG. 19a, sensor/emitter module 661b faces in the corresponding sideways (port) direction as well as the forward direction. The corresponding fairing 660 is relatively streamlined, having a V-shaped cross-section, with upper portion 660a and lower portion 660b in angular arrangement with respect to leading edge 690. The sensor/emitter module 661b comprises a pair of sensor/emitter arrays 678, also in angular arrangement and disposed above and below, respectively, of the reference plane B. The upper portion 660a and lower portion 660b are each substantially planar and each encompasses the full field of view (FOV_{b}) of the respective sensor/emitter array 678, thereby interfering minimally with operation of the sensor/emitter arrays 678, and thus with the transmission of energy in either direction therethrough. The sensor/emitter module 661a is similar, mutatis mutandis, to sensor/emitter module 661b.

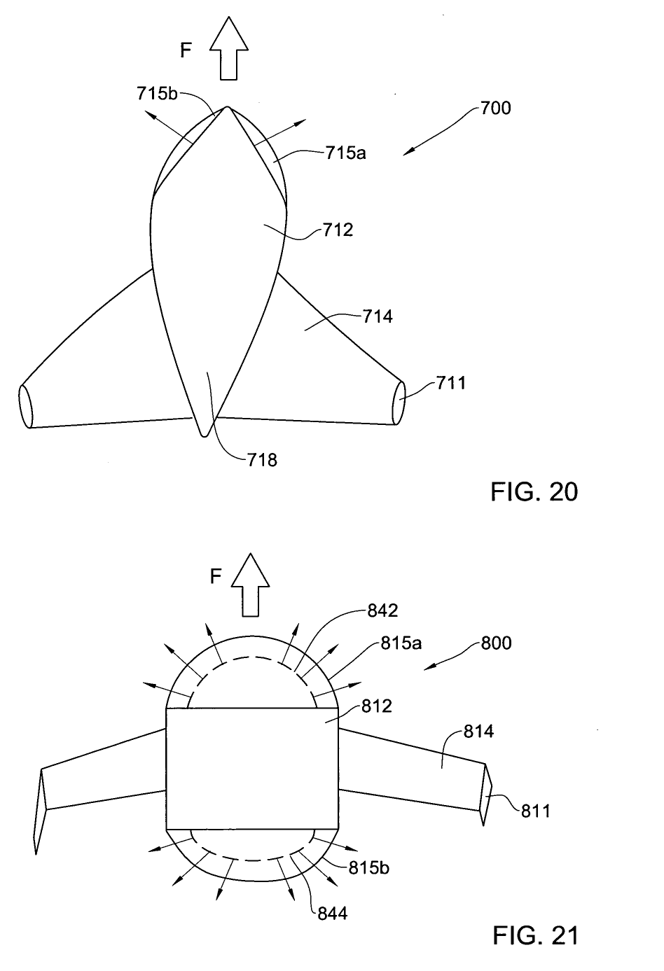

The air vehicle according to a seventh embodiment of the invention, designated 700 and illustrated in FIG. 20, comprises a fuselage 712 and wings 714 fixed thereto, including winglets 711, similar to the corresponding components of first or second embodiment or variations thereof, as described with respect thereto, mutatis mutandis, for example. However, in the seventh embodiment, the fuselage 712 only comprises two sensor/emitter modules 715a, 715b, each facing in the respective side direction and also in the forward direction, and the aft end 718 may be fully streamlined. While this embodiment only provides partial azimuthal cover (forward and partial sides), the fuselage may be designed having less drag than other embodiments, for example. In an alternative variation of this embodiment, the fuselage may comprises two sensor/emitter modules that are facing in the respective side direction and also in the forward direction, instead of facing the forward direction and the side directions, and the nose may be fully streamlined.

The air vehicle according to an eighth embodiment of the invention, designated 800 and illustrated in FIG. 21, comprises a fuselage 812 and wings 814 fixed thereto, including winglets 811, similar to the corresponding components of first through seventh embodiments or variations thereof, as described with respect thereto, mutatis mutandis, for example. However, in the eighth embodiment, the fuselage 812 comprises one forward mounted sensor/emitter module 815a, and one aft-mounted sensor/emitter module 815b.

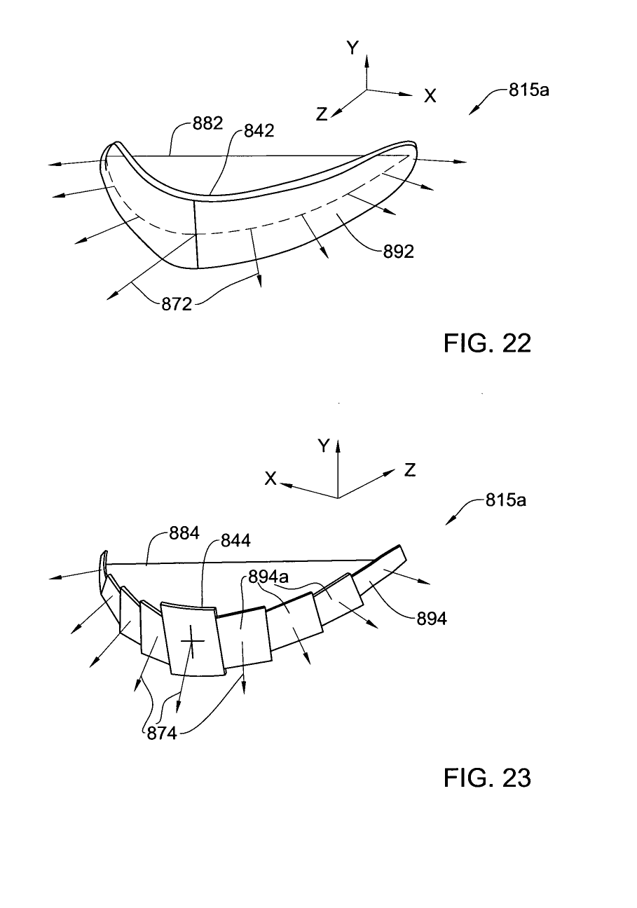

In this embodiment, and referring to FIGS. 22 and 23, the sensor/emitter modules 815a, 815b each comprise a sensor/emitter array 842, 844, respectively, that are non-planar, i.e., in which the respective sensing/emitting faces 892, 894, are not planar, though nevertheless elongated with respect to a respective elongation axis, 882, 884, which in these cases are generally parallel to the pitch axis x.

By way of example sensor/emitter array 842 is curved, and face 892 may be partially cylindrical, elongated along the curved direction, and defining a plurality of normals 872 defining a corresponding plurality of lines of sight, and thus the face 892 faces the forward direction as well as the two side directions.

Further by way of example, sensor/emitter array 842 is faceted, and face 894 comprises a plurality of facets 894n in juxtaposition, providing an elongated form to the array 815b. The plurality of facets 894n thus define a plurality of normals 874, which define a plurality of lines of sight, and thus the face 894 faces the aft direction as well as the two side directions.

In alternative variations of this embodiment, both sensor/emitter modules 815a, 815b comprise the curved sensor/emitter array of FIG. 22, while in other alternative variations of this embodiment, both sensor/emitter modules 815a, 815b comprise the faceted sensor/emitter array of FIG. 23.

In another alternative variation of the embodiment of FIGS. 21 to 23, the air vehicle is provided only with the forward mounted sensor module 815a, and the aft end of the fuselage may be fully streamlined. In another alternative variation of the embodiment of FIG. 21, the air vehicle is provided only with the aft mounted sensor module 815b and the forward end of the fuselage may be fully streamlined.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed example embodiments in accordance with the invention, it will be appreciated that many changes may be made therein without departing from the spirit of the invention.

1. An air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
a sensor/emitter arrangement configured for at least one of sensing and emitting energy in directions associated with a plurality of different lines of sight (LOS) with respect to said fuselage;
wherein said sensor/emitter arrangement comprises at least one sensor/emitter array, the or each said sensor/emitter array comprising a sensing/emitting face configured for said at least one of sensing and emitting energy and that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis; and
wherein said fuselage is configured for integrating said sensor/emitter arrangement therein for enabling optimizing operation of said sensor/emitter arrangement.

2. The air vehicle according to claim 1, wherein said elongation axis is generally aligned with said reference azimuthal plane of said air vehicle.

3. The air vehicle according to claim 1 or claim 2, wherein at least a part of said fuselage is formed having a generally oblate cross-section perpendicular to said longitudinal axis for accommodating therein at least a portion of said sensor/emitter arrangement, and wherein said vehicle comprises an inverse oblateness ratio, taken as a ratio of said fuselage width to said fuselage height, greater than unity.

4. The air vehicle according to claim 3, wherein said inverse oblateness ratio is greater than about 1.5.

5. The air vehicle according to any one of claims 1 to 4, wherein said fuselage comprises a first fineness ratio, taken as a ratio of said fuselage length to said fuselage width, of less than about 5.0.

6. The air vehicle according to any one of claims 1 to 5, wherein said wing arrangement lacks any portions thereof that intersect with or that is below said azimuthal reference plane.

7. The air vehicle according to any one of claims 1 to 6, wherein said sensor/emitter arrangement comprises a plurality of said sensor/emitter arrays, each sensor/emitter array being configured for operating to at least one of provide sensor data and emit energy for a respective portion of a 360 degree azimuth volume with respect to the air vehicle referenced to said at least one azimuthal reference plane.

8. The air vehicle according to claim 7, wherein said sensor/emitter arrangement is configured for operating with respect to a substantially continuous 360 degree azimuth volume with respect to the air vehicle referenced to said azimuthal reference plane.

9. The air vehicle according to any one of claims 7 to 8, wherein at least one said sensor/emitter array is arranged with the respective sensing/emitting face thereof facing one of said forward direction and said aft direction along the longitudinal axis.

10. The air vehicle according to any one of claims 7 to 9, wherein at least one said sensor/emitter array is arranged with the respective elongation axis thereof substantially parallel to said pitch axis of the air vehicle, and located at an aft end of said fuselage.

11. The air vehicle according to claim 10, wherein said aft end comprises an aerodynamically blunt aft end.

12. The air vehicle according to claim 10, wherein at least a majority of said aft end is closed and lacks a streamlined configuration.

13. The air vehicle according to any one of claims 10 to 12, wherein said aft end comprises a cross-section that is generally rounded in at least a majority of cross-sections taken perpendicular to the azimuthal reference plane and generally parallel to the longitudinal axis of the air vehicle.

14. The air vehicle according to any one of claims 9 to 13, wherein at least one said sensor/emitter array is arranged with the respective elongation axis thereof substantially inclined to said pitch axis and to said longitudinal axis, in plan view.

15. The air vehicle according to claim 14, wherein at least one said inclined elongation axis is inclined at an angle between about 10 degrees and about 80 degrees with respect to said longitudinal axis, in plan view.

16. The air vehicle according to claim 15, wherein at least one said inclined elongation axis is inclined at one of an angle of about 30 degrees or an angle of 60 degrees with respect to said longitudinal axis, in plan view.

17. The air vehicle according to any one of claims 9 to 17, comprising three said sensor/emitter arrays, arranged with the respective elongate axes along the sides of an imaginary triangle.

18. The air vehicle according to claim 18, wherein said triangle is an equilateral triangle or an isosceles triangle.

19. The air vehicle according to any one of claims 9 to 16, comprising four or more said sensor/emitter arrays, arranged with their respective elongate axes in symmetrical disposition with respect to said longitudinal axis.

20. The air vehicle according to any one of claims 9 to 19, wherein each sensor/emitter array has an array height dimension and an array width dimension, taken orthogonal to and along with, respectively, the elongate axis, and an aspect ratio of array width to array height for at least one said array is between about 1.5 and about 10.

21. The air vehicle according to any one of claims 7 to 20, each said sensor/emitter array being further configured for providing said sensor data in elevation below said azimuthal reference plane, at least for a respective portion of a 360 degree azimuth volume.

22. The air vehicle according to claim 21, wherein said sensor/emitter arrangement is configured for operating with respect to a hemispherical envelope centered on said fuselage and extending radially below said azimuthal reference plane.

23. The air vehicle according to any one of claims 7 to 22, each said sensor/emitter array being further configured operating with respect to elevation above said azimuthal reference plane, at least for a respective portion of said 360 degree azimuth volume.

24. The air vehicle according to any one of claims 9 to 23, wherein said sensor/emitter arrays are configured for providing substantially similar sensor/emitter performance one to another, at least with respect to one of: sensor maximum range, sensor/emitter field of view in azimuth, sensor/emitter field of view in elevation with respect to said azimuthal reference plane.

25. The air vehicle according to any one of claims 9 to 24, wherein said sensor/emitter arrangement comprises a radar arrangement, and each said sensor/emitter array comprise a respective radar array configured for at least detecting a target.

26. The air vehicle according to claim 25, wherein said radar arrays comprise phase radar arrays.

27. The air vehicle according to any one of claims 1 to 26, wherein said air vehicle comprises a propulsion system dorsally mounted on said fuselage.

28. The air vehicle according to any one of claims 1 to 27 wherein said air vehicle is configured as a UAV or as a manned air vehicle, and wherein said air vehicle is configured as a subsonic or a transonic air vehicle.

29. The air vehicle according to any one of claims 1 to 28, wherein the air vehicle is free of additional tail arrangement.

30. The air vehicle according to any one of claims 7 to 32, wherein each said sensor/emitter array is comprised in a respective compartment in said fuselage and facing a fairing that forms part of the outer skin of the air vehicle.

31. The air vehicle according to claim 30, wherein at least one said sensor/emitter array is a radar array, and the respective fairing thereof is made from a material that is substantially transparent to the radar beams transmitted from and/or received by the respective radar array, and wherein said fairings each comprise a smooth rounded shape.

32. The air vehicle according to any one of claims 1 to 31, wherein said fuselage has an outer surface that is faceted, and wherein each said sensor/emitter array comprises a respective said fairing that is substantially flat and spaced from the respective sensor/emitter array, and which forms part of an external skin of said air vehicle.

33. The air vehicle according to any one of claims 1 to 32, wherein said wing arrangement comprises a port wing and a starboard wing, each mounted to a corresponding side of said fuselage.

34. The air vehicle according to any one of claims 1 to 33, wherein said wing arrangement comprises an integral wing having a port wing part and a starboard wing part, and wherein said wing is mounted to said fuselage via a pylon structure, such that the dorsal surface of the fuselage is facing the underside of the integral wing.

35. The air vehicle according to any one of claims 7 to 35, wherein in plan view or in bottom view at least a majority of each said sensor/emitter array is free from superposition by said wings.

36. The air vehicle according to any one of claims 7 to 35, wherein said fuselage comprises cross-sections at planes corresponding to locations of respective said sensor/emitter arrays, wherein a majority of each said cross-section is occupied by the respective said array.

37. The air vehicle according to any one of claims 7 to 36, wherein said fuselage has a profile that is generally determined by the size, shape and locations of said sensor/emitter arrays.

38. The air vehicle according to any one of claims 7 to 39, wherein said sensor/emitter arrays are arranged in said fuselage around an imaginary center point, wherein the sensor/emitter arrays are spaced from said center point by respective spacings which are dimensionally similar to one another.

39. The air vehicle according to claim 38, wherein at least some of said spacings are not equal to one another, and wherein a maximum said spacing is larger than a minimum said spacing by less than a factor of 2 times said minimum spacing.

40. The air vehicle according to any one of claims 1 to 39, wherein sensor/emitter arrangement may include one or more of a radar jammer arrangement, a passive radar detector, a SIGINT module, an ELINT module, and a COMINT module, a guard antenna, IFF (identify friend or foe) elements, radio transmitting elements.

41. An air vehicle comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
a sensor/emitter arrangement configured for at least one of sensing and emitting energy in directions associated with a plurality of different lines of sight (LOS) with respect to said fuselage;
said fuselage being configured for integrating said sensor/emitter arrangement therein for enabling optimizing operation of said sensor/emitter arrangement, and said fuselage comprising a fuselage fineness ratio including at least one of:
a first fineness ratio, taken as a ratio of said fuselage length to said fuselage height, wherein said first fineness ratio is less than about 5;
a second fineness ratio, taken as a ratio of said fuselage length to said fuselage width, wherein said first fineness ratio is less than about 6;
an inverse oblateness ratio, taken as a ratio of said fuselage width to said fuselage height, wherein said inverse oblateness ratio is greater than 1.5.

42. The air vehicle according to claim 41, wherein the air vehicle is free of additional tail arrangement.

43. The air vehicle according to any one of claim 41 or 42, wherein at least a part of said fuselage is formed having a generally oblate cross-section perpendicular to said longitudinal axis for accommodating therein at least a portion of said sensor/emitter arrangement.

44. The air vehicle according to any one of claims 41 to 43, wherein said sensor/emitter arrangement comprises at least one sensor/emitter array, the or each said sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

45. The air vehicle according to claim 44, wherein said elongation axis is generally aligned with the reference azimuthal plane of said air vehicle.

46. The air vehicle according to any one of claims 44 to 45, wherein said sensor/emitter arrangement comprises a plurality of said sensor/emitter arrays, each sensor/emitter array being configured for operating to at least one of provide said sensor data and emit energy for a respective portion of a 360 degree azimuth volume with respect to the air vehicle referenced to the azimuthal reference plane.

47. The air vehicle according to claim 46, wherein said sensor/emitter arrangement is configured for operating with respect to a substantially continuous 360 degree azimuth volume with respect to the air vehicle referenced to said azimuthal reference plane.

48. The air vehicle according to any one of claims 46 to 47, wherein said wing arrangement lacks any portions thereof that intersect with or that is below said azimuthal reference plane.

49. The air vehicle according to any one of claims 46 to 48, wherein at least one said sensor/emitter array is arranged with the respective sensing/emitting face thereof facing one of said forward direction and said aft direction.

50. The air vehicle according to claim 49, wherein at least one said sensor/emitter array is arranged with the respective elongation axis thereof substantially parallel to said pitch axis of the air vehicle, and located at an aft end of said fuselage.

51. The air vehicle according to claim 50, wherein said aft end comprises an aerodynamically blunt aft end.

52. The air vehicle according to any one of claims 50 and 51, wherein at least a majority of said aft end is closed and lacks a streamlined configuration.

53. The air vehicle according to any one of claims 50 to 52, wherein said aft end comprises a cross-section that is generally rounded in at least a majority of cross-sections taken perpendicular to the azimuthal reference plane and generally parallel to the longitudinal axis of the air vehicle.

54. The air vehicle according to any one of claims 46 to 53, wherein at least one said sensor/emitter array is arranged with the respective elongation axis thereof substantially inclined to said pitch axis and to said longitudinal axis, in plan view.

55. The air vehicle according to claim 54, wherein at least one said inclined elongation axis is inclined at an angle between about 10 degrees and about 80 degrees with respect to said longitudinal axis, in plan view.

56. The air vehicle according to claim 55, wherein at least one said inclined elongation axis is inclined at one of an angle of about 30 degrees with respect to said longitudinal axis, and an angle of 60 degrees with respect to said longitudinal axis, in plan view.

57. The air vehicle according to any one of claims 46 to 56, comprising three said sensor/emitter arrays, arranged with the respective elongate axes along the sides of an imaginary triangle.

58. The air vehicle according to claim 57, wherein said triangle is an isosceles triangle or an equilateral triangle.

59. The air vehicle according to any one of claims 46 to 56, comprising four or more said sensor/emitter arrays, arranged with their respective elongate axes in symmetrical disposition with respect to said longitudinal axis.

60. The air vehicle according to any one of claims 46 to 59, wherein each sensor/emitter array has an array height dimension and an array width dimension, taken orthogonal to and along with, respectively, the elongate axis, and an aspect ratio of array width to array height for at least one said array is between about 1.5 and about 10.

61. The air vehicle according to any one of claims 46 to 60, each said sensor/emitter array being further configured for operating with respect to elevation below said azimuthal reference plane, at least for a respective portion of a 360 degree azimuth volume.

62. The air vehicle according to claim 61, wherein said sensor/emitter arrangement is configured for operating with respect to a hemispherical envelope centered on said fuselage and extending radially below said azimuthal reference plane.

63. The air vehicle according to any one of claims 46 to 62, each said sensor/emitter array being further configured for operating with respect to elevation above said azimuthal reference plane, at least for a respective portion of said 360 degree azimuth volume.

64. The air vehicle according to any one of claims 46 to 64, wherein said sensor/emitter arrays are configured for providing substantially similar sensor/emitter performance one to another, at least with respect to one of:
sensor/emitter maximum range, sensor/emitter field of view in azimuth, sensor/emitter field of view in elevation with respect to said azimuthal reference plane.

65. The air vehicle according to any one of claims 41 to 64, wherein sensor/emitter arrangement may include one or more of: a radar jammer arrangement, a passive radar detector, a SIGINT module, an ELINT module, and a COMINT module, a guard antenna, IFF (identify friend or foe) elements, radio transmitting elements.

66. The air vehicle according to any one of claims 46 to 65, wherein said sensor/emitter arrangement comprises a radar arrangement, and each said sensor/emitter array comprises a respective radar array for at least detecting a target.

67. The air vehicle according to claim 66, wherein said radar arrays comprise phase radar arrays.

68. The air vehicle according to any one of claims 41 to 67, wherein said air vehicle comprises a propulsion system dorsally mounted on said fuselage.

69. The air vehicle according to any one of claims 41 to 68 wherein said air vehicle is configured as a UAV or as a manned air vehicle and wherein said air vehicle is configured as a subsonic or a transonic air vehicle.

70. The air vehicle according to any one of claims 46 to 69, wherein each said sensor/emitter array is comprised in a respective compartment in said fuselage and facing a fairing that forms part of the outer skin of the air vehicle.

71. The air vehicle according to claim 70, wherein at least one said sensor/emitter array is a radar array, and the respective fairing thereof is made from a material that is substantially transparent to the radar beams transmitted from and/or received by the respective radar array.

72. The air vehicle according to any one of claims 70 to 71, wherein said fairings each comprise a smooth rounded shape.

73. The air vehicle according to any one of claims 41 to 72, wherein said fuselage has an outer surface that is faceted, and wherein each said sensor/emitter array comprises a respective said fairing that is substantially flat and spaced from the respective sensor array, and which forms part of an external skin of said air vehicle.

74. The air vehicle according to any one of claims 41 to 73, wherein said wing arrangement comprises a port wing and a starboard wing, each mounted to a corresponding side of said fuselage.

75. The air vehicle according to any one of claims 41 to 74, wherein said wing arrangement comprises a integral wing having a port wing part and a starboard wing part, and wherein said wing is mounted to said fuselage via a pylon structure, such that the dorsal surface of the fuselage is facing the underside of the wing.

76. The air vehicle according to any one of claims 44 to 75, wherein in plan view or in bottom view at least a majority of each said sensor/emitter array is free from superposition by said wings

77. The air vehicle according to any one of claims 46 to 76, wherein said fuselage comprises cross-sections at planes corresponding to locations of respective said sensor/emitter arrays, wherein a majority of each said cross-section is occupied by the respective said array.

78. The air vehicle according to any one of claims 46 to 77, wherein said fuselage has a profile that is generally determined by the size, shape and locations of said sensor/emitter arrays.

79. The air vehicle according to any one of claims 46 to 78, wherein said sensor/emitter arrays are arranged in said fuselage around an imaginary center point, wherein the sensor/emitter arrays are spaced from said center point by respective spacings which are dimensionally similar to one another.

80. The air vehicle according to claim 79, wherein at least some of said spacings are not equal to one another, and wherein a maximum said spacing is larger than a minimum said spacing by less than a factor of 2 times said minimum spacing.

81. An air vehicle comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
a sensor/emitter arrangement configured for at least one of sensing and emitting energy in directions associated with a plurality of different lines of sight (LOS) with respect to said fuselage;
the fuselage being configured for integrating said sensor/emitter arrangement therein for enabling optimizing operation of said sensor/emitter arrangement;
the air vehicle being free of additional tail arrangement.

82. The air vehicle according to claim 81, wherein at least a part of said fuselage is formed having a generally oblate cross-section perpendicular to said longitudinal axis for accommodating therein at least a portion of said sensor/emitter arrangement.

83. The air vehicle according to any one of claim 81 or 82, wherein said vehicle comprises an inverse oblateness ratio, taken as a ratio of said fuselage width to said fuselage height, greater than unity, and wherein said inverse oblateness ratio is greater than about 1.5.

84. The air vehicle according to any one of claims 81 to 83, wherein said fuselage comprises a first fineness ratio, taken as a ratio of said fuselage length to said fuselage width, of less than about 5.0.

85. The air vehicle according to any one of claims 81 to 84, wherein sensor/emitter arrangement may include one or more of: a radar jammer arrangement, a passive radar detector, a SIGINT module, an ELINT module, and a COMMIT module, a guard antenna, IFF (identify friend or foe) elements, radio transmitting elements.

86. The air vehicle according to any one of claims 81 to 85, wherein said sensor/emitter arrangement comprises at least one sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

87. The air vehicle according to claim 44, wherein said elongation axis is generally aligned with an azimuthal plane of said air vehicle.

88. The air vehicle according to any one of claims 86 to 87, wherein said sensor/emitter arrangement comprises a plurality of said sensor/emitter arrays, each said sensor/emitter array being configured for operating to at least one of provide sensor data and emit energy for a respective portion of a 360 degree azimuth volume with respect to the air vehicle referenced to said at least one azimuthal reference plane.

89. The air vehicle according to claim 88, wherein said sensor/emitter arrangement is configured for operating with respect to a substantially continuous 360 degree azimuth volume with respect to the air vehicle referenced to said azimuthal reference plane.

90. The air vehicle according to any one of claim 88 or 89, wherein said wing arrangement lacks any portions thereof that intersect with or that is below said azimuthal reference plane.

91. The air vehicle according to any one of claim 88 or 90, wherein at least one said sensor/emitter array is arranged with the respective sensing/emitting face thereof facing one of said forward direction and said aft direction.

92. The air vehicle according to claim 91, wherein at least one said sensor/emitter array is arranged with the respective elongation axis thereof substantially parallel to said pitch axis of the air vehicle, and located at an aft end of said fuselage.

93. The air vehicle according to claim 92, wherein said aft end comprises an aerodynamically blunt aft end.

94. The air vehicle according to claim 92, wherein at least a majority of said aft end is closed and lacks a streamlined configuration.

95. The air vehicle according to any one of claims 92 to 94, wherein said aft end comprises a cross-section that is generally rounded in at least a majority of cross-sections taken perpendicular to the azimuthal reference plane and generally parallel to the longitudinal axis of the air vehicle.

96. The air vehicle according to any one of claims 91 to 95, wherein at least one said sensor/emitter array is arranged with the respective elongation axis thereof substantially inclined to said pitch axis and to said longitudinal axis, in plan view.

97. The air vehicle according to claim 96, wherein at least one said inclined elongation axis is inclined at an angle between about 10 degrees and about 80 degrees with respect to said longitudinal axis.

98. The air vehicle according to claim 97, wherein at least one said inclined elongation axis is inclined at one of an angle of about 30 degrees or an angle of 60 degrees with respect to said longitudinal axis.

99. The air vehicle according to any one of claims 88 to 98, comprising three said arrays, arranged with the respective elongate axes along the sides of an imaginary triangle.

100. The air vehicle according to claim 99, wherein said triangle is an equilateral triangle or an isosceles triangle.

101. The air vehicle according to any one of claims 88 to 98, comprising four or more said sensor/emitter arrays, arranged with their respective elongate axes in symmetrical disposition with respect to said longitudinal axis.

102. The air vehicle according to any one of claims 88 to 101, wherein each sensor/emitter array has an array height dimension and an array width dimension, taken orthogonal to and along with, respectively, the elongate axis, and an aspect ratio of array width to array height for at least one said array is between about 1.5 and about 10.

103. The air vehicle according to any one of claims 88 to 102, each said sensor/emitter array being further configured operating with respect to elevation below said azimuthal reference plane, at least for a respective portion of a 360 degree azimuth volume.

104. The air vehicle according to claim 103, wherein said sensor/emitter arrangement is configured for operating with respect to a hemispherical envelope centered on said fuselage and extending radially below said azimuthal reference plane.

105. The air vehicle according to any one of claims 88 to 104, each said sensor/emitter array being further configured operating with respect to elevation above said azimuthal reference plane, at least for a respective portion of said 360 degree azimuth volume.

106. The air vehicle according to any one of claims 88 to 105, wherein said sensor/emitter arrays are configured for providing substantially similar sensor/emitter performance one to another, at least with respect to one of: sensor/emitter maximum range, sensor/emitter field of view in azimuth, sensor/emitter field of view in elevation with respect to said azimuthal reference plane.

107. The air vehicle according to any one of claims 88 to 106, wherein said sensor/emitter arrangement comprises a radar arrangement, and each said sensor/emitter array comprise a respective radar array for at least detecting a target.

108. The air vehicle according to claim 107, wherein said radar arrays comprise phase radar arrays.

109. The air vehicle according to any one of claims 81 to 108 wherein said air vehicle is configured as a UAV or as a manned air vehicle, and wherein said air vehicle is configured as a subsonic or a transonic air vehicle.

110. The air vehicle according to any one of claims 88 to 109, wherein each said sensor/emitter array is comprised in a respective compartment in said fuselage and facing a fairing that forms part of the outer skin of the air vehicle.

111. The air vehicle according to claim 110, wherein at least one said sensor/emitter array is a radar array, and the respective fairing thereof is made from a material that is substantially transparent to the radar beams transmitted from and/or received by the respective radar array.

112. The air vehicle according to any one of claims 110 to 111, wherein said fairings each comprise a smooth rounded shape.

113. The air vehicle according to any one of claims 88 to 115, wherein said fuselage has an outer surface that is faceted, and wherein each said sensor/emitter array comprises a respective said fairing that is substantially flat and spaced from the respective sensor array, and which forms part of an external skin of said air vehicle.

114. The air vehicle according to any one of claims 81 to 113, wherein said wing arrangement comprises a port wing and a starboard wing, each mounted to a corresponding side of said fuselage.

115. The air vehicle according to any one of claims 81 to 113, wherein said wing arrangement comprises a integral wing having a port wing part and a starboard wing part, and wherein said wing is mounted to said fuselage via a pylon structure, such that the dorsal surface of the fuselage is facing the underside of the integral wing.

116. The air vehicle according to any one of claims 86 to 119, wherein in plan view or in bottom view at least a majority of the or each said sensor/emitter array is free from superposition by said wings.

117. The air vehicle according to any one of claims 88 to 116, wherein said fuselage comprises cross-sections at planes corresponding to locations of respective said sensor/emitter arrays, wherein a majority of each said cross-section is occupied by the respective said array.

118. The air vehicle according to any one of claims 88 to 117, wherein said fuselage has a profile that is generally determined by the size, shape and locations of said sensor/emitter arrays.

119. The air vehicle according to any one of claims 88 to 118, wherein said sensor/emitter arrays are arranged in said fuselage around an imaginary center point, wherein the sensor/emitter arrays are spaced from said center point by respective spacings which are dimensionally similar to one another.

120. The air vehicle according to claim 119, wherein at least some of said spacings are not equal to one another, and wherein a maximum said spacing is larger than a minimum said spacing by less than a factor of 2 times said minimum spacing.

121. An airborne radar system configured for providing surveillance coverage throughout at least a portion of a 360 degree azimuth volume, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
a radar system comprising a plurality of antenna structures, each having a respective field of view;
the fuselage comprising a plurality of internal compartments peripherally disposed with respect thereto and each compartment configured for enabling integrating therein a respective said antenna structure;
wherein at least one said antenna structure comprises a respective sensing/emitting face that is elongated along an elongation axis and is arranged with the respective sensing/emitting face thereof at least partially facing one of a forward direction and an aft direction along said longitudinal axis, and at least partially facing at least one side direction along said pitch axis.

122. The air vehicle according to claim 1, wherein said elongation axis is generally aligned with said reference azimuthal plane of said air vehicle corresponding to said azimuthal volume.

123. The air vehicle according to any one of claim 121 or 122, wherein said vehicle comprises an inverse oblateness ratio, taken as a ratio of said fuselage width to said fuselage height, greater than unity, and wherein said inverse oblateness ratio is greater than about 1.5.

124. The air vehicle according to any one of claims 121 to 124, wherein said fuselage comprises a first fineness ratio, taken as a ratio of said fuselage length to said fuselage width, of less than about 5.0.

125. The air vehicle according to any one of claims 121 to 126, wherein said antenna structures each comprises a radar array, each radar array being configured for providing radar data for a respective portion of said 360 degree azimuth volume with respect to the air vehicle.

126. The air vehicle according to claim 127, wherein said radar system is configured for providing said radar data for a substantially continuous 360 degree azimuth volume with respect to the air vehicle.

127. The air vehicle according to any one of claim 127 or 128, wherein said wing arrangement lacks any portions thereof that intersect with or that is below said azimuthal reference plane.

128. The air vehicle according to any one of claims 121 to 127, wherein at least one said antenna structure is arranged with the respective sensing/emitting face thereof facing one of said forward direction and said aft direction.

129. The air vehicle according to any one of claims 121 to 128, wherein at least one said radar array is arranged with the respective elongation axis thereof substantially parallel to said pitch axis of the air vehicle, and located at an aft end of said fuselage.

130. The air vehicle according to claim 129, wherein said aft end comprises an aerodynamically blunt aft end.

131. The air vehicle according to any one of claims 129 and 130, wherein at least a majority of said aft end is closed and lacks a streamlined configuration.

132. The air vehicle according to any one of claims 129 to 131, wherein said aft end comprises a cross-section that is generally rounded in at least a majority of cross-sections taken perpendicular to the azimuthal reference plane and generally parallel to the longitudinal axis of the air vehicle.

133. The air vehicle according to any one of claims 126 to 132, wherein at least one said radar array is arranged with the respective elongation axis thereof substantially inclined to said pitch axis and to said longitudinal axis, in plan view.

134. The air vehicle according to claim 133, wherein at least one said inclined elongation axis is inclined at an angle between about 10 degrees and about 80 degrees with respect to said longitudinal axis, in plan view.

135. The air vehicle according to claim 134, wherein at least one said inclined elongation axis is inclined at one of an angle of about 30 degrees or an angle of 60 degrees with respect to said longitudinal axis, in plan view.

136. The air vehicle according to any one of claims 126 to 135, comprising three said arrays, arranged with the respective elongate axes along the sides of an imaginary triangle.

137. The air vehicle according to claim 136, wherein said triangle is an equilateral triangle or an isosceles triangle.

138. The air vehicle according to any one of claims 126 to 134, comprising four or more said radar arrays, arranged with their respective elongate axes in symmetrical disposition with respect to said longitudinal axis.

139. The air vehicle according to any one of claims 126 to 138, wherein each radar array has an array height dimension and an array width dimension, taken orthogonal to and along with, respectively, the elongate direction, and an aspect ratio of array width to array height for at least one said array is between about 1.5 and about 10.

140. The air vehicle according to any one of claims 126 to 139, each said radar array being further configured for providing said radar data in elevation below said azimuthal reference plane, at least for a respective portion of a 360 degree azimuth volume.

141. The air vehicle according to claim 140, wherein said radar arrangement is configured for providing said radar data from a hemispherical envelope centered on said fuselage and extending radially below said azimuthal reference plane.

142. The air vehicle according to any one of claims 126 to 141, each said radar array being further configured for providing said radar data in elevation above said azimuthal reference plane, at least for a respective portion of said 360 degree azimuth volume.

143. The air vehicle according to any one of claims 126 to 142, wherein said radar arrays are configured for providing substantially similar radar performance one to another, at least with respect to one of: maximum range, field of view in azimuth, field of view in elevation with respect to said azimuthal reference plane.

144. The air vehicle according to any one of claims 126 to 143, wherein said radar arrays comprise phase radar arrays.

145. The air vehicle according to any one of claims 121 to 144, wherein said air vehicle comprises a propulsion system dorsally mounted on said fuselage.

146. The air vehicle according to any one of claims 121 to 145 wherein said air vehicle is configured as a UAV or as a manned air vehicle, and wherein said air vehicle is configured as a subsonic or a transonic air vehicle.

147. The air vehicle according to any one of claims 126 to 146, wherein each said radar array is mounted in a respective said compartment in said fuselage and facing a fairing that forms part of the outer skin of the air vehicle.

148. The air vehicle according to claim 147, wherein said fairings are made from a material that is substantially transparent to the radar beams transmitted from and/or received by the respective radar array.

149. The air vehicle according to any one of claims 147 to 148, wherein said fairings each comprise a smooth rounded shape.

150. The air vehicle according to any one of claims 147 to 148, wherein said fuselage has an outer surface that is faceted, and wherein each said radar array comprises a respective said fairing that is substantially flat and spaced from the respective sensor array, and which forms part of an external skin of said air vehicle.

151. The air vehicle according to any one of claims 121 to 150, wherein said wing arrangement comprises a port wing and a starboard wing, each mounted to a corresponding side of said fuselage.

152. The air vehicle according to any one of claims 121 to 150, wherein said wing arrangement comprises a integral wing having a port wing part and a starboard wing part, and wherein said wing is mounted to said fuselage via a pylon structure, such that the dorsal surface of the fuselage is facing the underside of the integral wing.

153. The air vehicle according to any one of claims 126 to 152, wherein in plan view or in bottom view at least a majority of each said radar array is free from superposition by said wings.

154. The air vehicle according to any one of claims 121 to 153, the air vehicle being free of additional tail arrangement.

155. The air vehicle according to any one of claims 121 to 154, further comprising one or more additional sensors or transmitters accommodated in said compartments.

156. The air vehicle according to claim 155, wherein said additional sensors or transmitters may include one or more of a radar jammer arrangement, a passive radar detector, a SIGINT module, an ELINT module, and a COMINT module, a guard antenna, IFF (identify friend or foe) elements, radio transmitting elements.

157. The air vehicle according to any one of claims 121 to 156, wherein said fuselage comprises cross-sections at planes corresponding to locations of respective said radar arrays, wherein a majority of each said cross-section is occupied by the respective said array.

158. The air vehicle according to any one of claims 121 to 157, wherein said fuselage has a profile that is generally determined by the size, shape and locations of said radar arrays.

159. The air vehicle according to any one of claims 121 to 158, wherein said sensor/emitter arrays are arranged in said fuselage around an imaginary center point, wherein the radar arrays are spaced from said center point by respective spacings which are dimensionally similar to one another.

160. The air vehicle according to claim 159, wherein at least some of said spacings are not equal to one another, and wherein a maximum said spacing is larger than a minimum said spacing by less than a factor of 2 times said minimum spacing.

161. An air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
the fuselage comprising a blunt aft end; and
the air vehicle being free of additional tail arrangement.

162. The air vehicle according to claim 161, wherein said fuselage is configured for integrating said sensor/emitter arrangement therein for enabling optimizing operation of said sensor/emitter arrangement, wherein said sensor/emitter arrangement comprises at least one sensor/emitter array, the or each said sensor/emitter array comprising a sensing/emitting face that is elongated with respect to an elongation axis, and configured for enabling at least one said sensor/emitter array to be arranged with the respective sensing/emitting face thereof at least partially facing one of a forward direction and an aft direction along said longitudinal axis, and at least partially facing at least one side direction along said pitch axis.

163. The air vehicle according to claim 162, further comprising the sensor/emitter arrangement, wherein the sensor/emitter arrangement is configured for at least one of sensing and emitting energy in directions associated with a plurality of different lines of sight (LOS) with respect to said fuselage.

164. The air vehicle according to claim 163, wherein said sensor/emitter arrangement comprises at least one sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

165. The air vehicle according to claim 164, wherein said elongation axis is generally aligned with an azimuthal plane of said air vehicle.

166. The air vehicle according to any one of claims 162 to 165, wherein at least a part of said fuselage is formed having a generally oblate cross-section perpendicular to said longitudinal axis for accommodating therein at least a portion of the sensor/emitter arrangement, and wherein said inverse oblateness ratio is greater than about 1.5.

167. The air vehicle according to any one of claims 161 to 166, wherein said fuselage comprises a first fineness ratio, taken as a ratio of said fuselage length to said fuselage width, of less than about 5.0 or less than about 2.0.

168. The air vehicle according to any one of claims 162 to 167, wherein said sensor/emitter arrangement comprises a plurality of said sensor/emitter arrays, each sensor/emitter array being configured for operating to at least one of provide sensor data and emit energy for a respective portion of a 360 degree azimuth volume with respect to the air vehicle referenced to at least one azimuthal reference plane.

169. The air vehicle according to claim 168, wherein said sensor/emitter arrangement is configured for operating with respect to a substantially continuous 360 degree azimuth volume with respect to the air vehicle referenced to said azimuthal reference plane.

170. The air vehicle according to any one of claim 168 or 169, wherein said wing arrangement lacks any portions thereof that intersect with or that is below said azimuthal reference plane.

171. The air vehicle according to any one of claims 168 to 170, wherein at least one said sensor/emitter array is arranged with the respective sensing/emitting face thereof facing one of said forward and said aft direction.

172. The air vehicle according to any one of claims 168 to 171, wherein at least one said sensor/emitter array is arranged with the respective elongation axis thereof substantially parallel to said pitch axis of the air vehicle, and located at an aft end of said fuselage.

173. The air vehicle according to claim 172, wherein at least a majority of said aft end is closed and lacks a streamlined configuration.

174. The air vehicle according to any one of claims 161 to 173, wherein said aft end comprises a cross-section that is generally rounded in at least a majority of cross-sections taken perpendicular to the azimuthal reference plane and generally parallel to the longitudinal axis of the air vehicle.

175. The air vehicle according to any one of claims 168 to 174, wherein at least one said sensor/emitter array is arranged with the respective elongation axis thereof substantially inclined to said pitch axis and to said longitudinal axis, in plan view.

176. The air vehicle according to claim 175, wherein at least one said inclined elongation axis is inclined at an angle between about 10 degrees and about 80 degrees with respect to said longitudinal axis, in plan view.

177. The air vehicle according to claim 176, wherein at least one said inclined elongation axis is inclined at one of an angle of about 30 degrees or an angle of 60 degrees with respect to said longitudinal axis, in plan view.

178. The air vehicle according to any one of claims 168 to 177, comprising three said arrays, arranged with the respective elongate axes along the sides of an imaginary triangle.

179. The air vehicle according to claim 178, wherein said triangle is an equilateral triangle or an isosceles triangle.

180. The air vehicle according to any one of claims 168 to 176, comprising four or more said sensor/emitter arrays, arranged with their respective elongate axes in symmetrical disposition with respect to said longitudinal axis.

181. The air vehicle according to any one of claims 168 to 180, wherein each sensor/emitter array has an array height dimension and an array width dimension, taken orthogonal to and along with, respectively, the elongate direction, and an aspect ratio of array width to array height for at least one said array is between about 1.5 and about 10.

182. The air vehicle according to any one of claims 168 to 181, each said sensor/emitter array being further configured for operating with respect to elevation below said azimuthal reference plane, at least for a respective portion of a 360 degree azimuth volume.

183. The air vehicle according to claim 182, wherein said sensor/emitter arrangement is configured for operating with respect to a hemispherical envelope centered on said fuselage and extending radially below said azimuthal reference plane.

184. The air vehicle according to any one of claims 168 to 183, each said sensor/emitter array being further configured for operating with respect to elevation above said azimuthal reference plane, at least for a respective portion of said 360 degree azimuth volume.

185. The air vehicle according to any one of claims 168 to 184, wherein said sensor/emitter arrays are configured for providing substantially similar sensor/emitter performance one to another, at least with respect to one of: sensor/emitter maximum range, sensor/emitter field of view in azimuth, sensor/emitter field of view in elevation with respect to said azimuthal reference plane.

186. The air vehicle according to any one of claims 168 to 185, wherein said sensor/emitter arrangement comprises a radar arrangement, and each said sensor/emitter array comprise a respective radar array for at least detecting a target.

187. The air vehicle according to claim 186, wherein said radar arrays comprise phase radar arrays.

188. The air vehicle according to any one of claims 161 to 187, wherein said air vehicle comprises a propulsion system dorsally mounted on said fuselage.

189. The air vehicle according to any one of claims 161 to 188 wherein said air vehicle is configured as a UAV or as a manned air vehicle, and wherein said air vehicle is configured as a subsonic or a transonic air vehicle.

190. The air vehicle according to any one of claims 168 to 189, wherein each said sensor/emitter array is comprised in a respective compartment in said fuselage and facing a fairing that forms part of the outer skin of the air vehicle.

191. The air vehicle according to claim 190, wherein at least one said sensor/emitter array is a radar array, and the respective fairing thereof is made from a material that is substantially transparent to the radar beams transmitted from and/or received by the respective radar array.

192. The air vehicle according to any one of claims 190 to 191, wherein said fairings each comprise a smooth rounded shape.

193. The air vehicle according to any one of claims 161 to 195, wherein said fuselage has an outer surface that is faceted, and wherein each said sensor/emitter array comprises a respective said fairing that is substantially flat and spaced from the respective sensor array, and which forms part of an external skin of said air vehicle.

194. The air vehicle according to any one of claims 161 to 193, wherein said wing arrangement comprises a port wing and a starboard wing, each mounted to a corresponding side of said fuselage.

195. The air vehicle according to any one of claims 161 to 193, wherein said wing arrangement comprises a integral wing having a port wing part and a starboard wing part, and wherein said wing is mounted to said fuselage via a pylon structure, such that the dorsal surface of the fuselage is facing the underside of the integral wing.

196. The air vehicle according to any one of claims 168 to 195, wherein in plan view or in bottom view at least a majority of each said sensor/emitter array is free from superposition by said wings.

197. The air vehicle according to any one of claims 168 to 196, wherein said fuselage comprises cross-sections at planes corresponding to locations of respective said sensor/emitter arrays, wherein a majority of each said cross-section is occupied by the respective said array.

198. The air vehicle according to any one of claims 168 to 197, wherein said fuselage has a profile that is generally determined by the size, shape and locations of said sensor/emitter arrays.

199. The air vehicle according to any one of claims 168 to 198, wherein said sensor/emitter arrays are arranged in said fuselage around an imaginary center point, wherein the sensor/emitter arrays are spaced from said center point by respective spacings which are dimensionally similar to one another.

200. The air vehicle according to claim 199, wherein at least some of said spacings are not equal to one another, and wherein a maximum said spacing is larger than a minimum said spacing by less than a factor of 2 times said minimum spacing.

201. An air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
said fuselage comprising a blunt aft end; and
said fuselage comprising a fuselage fineness ratio including at least one of:
a first fineness ratio, taken as a ratio of said fuselage length to said fuselage height, wherein said first fineness ratio is less than about 5;
a second fineness ratio, taken as a ratio of said fuselage length to said fuselage width, wherein said first fineness ratio is less than about 6;
an inverse oblateness ratio, taken as a ratio of said fuselage width to said fuselage height, wherein said inverse oblateness ratio is greater than 1.5.

202. The air vehicle according to claim 201, wherein said fuselage is configured for integrating said sensor/emitter arrangement therein for enabling optimizing operation of said sensor/emitter arrangement, wherein said sensor/emitter arrangement comprises at least one sensor/emitter array, the or each said sensor/emitter array comprising a sensing/emitting face that is elongated with respect to an elongation axis, and configured for enabling at least one said sensor/emitter array to be arranged with the respective sensing/emitting face thereof at least partially facing one of a forward direction and an aft direction along said longitudinal axis, and at least partially facing at least one side direction along said pitch axis.

203. The air vehicle according to claim 202, further comprising the sensor/emitter arrangement, wherein the sensor/emitter arrangement is configured for at least one of sensing and emitting energy in directions associated with a plurality of different lines of sight (LOS) with respect to said fuselage.

204. The air vehicle according to claim 203, wherein said sensor/emitter arrangement comprises at least one sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

205. The air vehicle according to claim 204, wherein said elongation axis is generally aligned with an azimuthal plane of said air vehicle.

206. The air vehicle according to any one of claims 201 to 205, wherein the air vehicle is free of additional tail arrangement.

207. The air vehicle according to any one of claims 202 to 206, wherein at least a part of said fuselage is formed having a generally oblate cross-section perpendicular to said longitudinal axis for accommodating therein at least a portion of said sensor/emitter arrangement.

208. The air vehicle according to any one of claims 203 to 207, wherein said sensor/emitter arrangement comprises a plurality of said sensor/emitter arrays, each sensor/emitter array being configured for operating to at least one of provide sensor data and emit energy for a respective portion of a 360 degree azimuth volume with respect to the air vehicle referenced to at least one azimuthal reference plane.

209. The air vehicle according to claim 208, wherein said sensor/emitter arrangement is configured for operating with respect to a substantially continuous 360 degree azimuth volume with respect to the air vehicle referenced to said azimuthal reference plane.

210. The air vehicle according to any one of claim 208 or 209, wherein said wing arrangement lacks any portions thereof that intersect with or that is below said azimuthal reference plane.

211. The air vehicle according to any one of claims 208 to 210, wherein at least one said sensor/emitter array is arranged with the respective sensing/emitting face thereof facing one of said forward and said aft direction.

212. The air vehicle according to any one of claims 208 to 211, wherein at least one said sensor/emitter array is arranged with the respective elongation axis thereof substantially parallel to said pitch axis of the air vehicle, and located at an aft end of said fuselage.

213. The air vehicle according to claim 212, wherein at least a majority of said aft end is closed and lacks a streamlined configuration.

214. The air vehicle according to any one of claims 201 to 213, wherein said aft end comprises a cross-section that is generally rounded in at least a majority of cross-sections taken perpendicular to the azimuthal reference plane and generally parallel to the longitudinal axis of the air vehicle.

215. The air vehicle according to any one of claims 208 to 214, wherein at least one said sensor/emitter array is arranged with the respective elongation axis thereof substantially inclined to said pitch axis and to said longitudinal axis, in plan view.

216. The air vehicle according to claim 215, wherein at least one said inclined elongation axis is inclined at an angle between about 10 degrees and about 80 degrees with respect to said longitudinal axis.

217. The air vehicle according to claim 216, wherein at least one said inclined elongation axis is inclined at an angle of about 30 degrees or 60 degrees with respect to said longitudinal axis.

218. The air vehicle according to any one of claims 208 to 217, comprising three said arrays, arranged with the respective elongate axes along the sides of an imaginary triangle.

219. The air vehicle according to claim 218, wherein said triangle is an equilateral triangle or an isosceles triangle.

220. The air vehicle according to any one of claims 208 to 219, comprising four or more said sensor/emitter arrays, arranged with their respective elongate axes in symmetrical disposition with respect to said longitudinal axis.

221. The air vehicle according to any one of claims 208 to 220, wherein each sensor/emitter array has an array height dimension and an array width dimension, taken orthogonal to and along with, respectively, the elongate direction, and an aspect ratio of array width to array height for at least one said array is between about 1.5 and about 10.

222. The air vehicle according to any one of claims 208 to 221, each said sensor/emitter array being further configured operating with respect to elevation below said azimuthal reference plane, at least for a respective portion of a 360 degree azimuth volume.

223. The air vehicle according to claim 222, wherein said sensor/emitter arrangement is configured for operating with respect to a hemispherical envelope centered on said fuselage and extending radially below said azimuthal reference plane.

224. The air vehicle according to any one of claims 208 to 223, each said sensor/emitter array being further configured for operating with respect to elevation above said azimuthal reference plane, at least for a respective portion of said 360 degree azimuth volume.

225. The air vehicle according to any one of claims 208 to 224, wherein said sensor/emitter arrays are configured for providing substantially similar sensor/emitter performance one to another, at least with respect to one of: sensor/emitter maximum range, sensor/emitter field of view in azimuth, sensor/emitter field of view in elevation with respect to said azimuthal reference plane.

226. The air vehicle according to any one of claims 208 to 225, wherein said sensor/emitter arrangement comprises a radar arrangement, and each said sensor/emitter array comprise a respective radar array for at least detecting a target.

227. The air vehicle according to claim 226, wherein said radar arrays comprise phase radar arrays.

228. The air vehicle according to any one of claims 201 to 227, wherein said air vehicle comprises a propulsion system dorsally mounted on said fuselage.

229. The air vehicle according to any one of claims 201 to 228 wherein said air vehicle is configured as a UAV or as a manned air vehicle, and wherein said air vehicle is configured as a subsonic or a transonic air vehicle.

230. The air vehicle according to any one of claims 208 to 229, wherein each said sensor/emitter array is comprised in a respective compartment in said fuselage and facing a fairing that forms part of the outer skin of the air vehicle.

231. The air vehicle according to claim 230, wherein at least one said sensor/emitter array is a radar array, and the respective fairing thereof is made from a material that is substantially transparent to the radar beams transmitted from and/or received by the respective radar array.

232. The air vehicle according to any one of claims 230 to 231, wherein said fairings each comprise a smooth rounded shape.

233. The air vehicle according to any one of claims 201 to 232, wherein said fuselage has an outer surface that is faceted, and wherein each said sensor/emitter array comprises a respective said fairing that is substantially flat and spaced from the respective sensor array, and which forms part of an external skin of said air vehicle.

234. The air vehicle according to any one of claims 201 to 233, wherein said wing arrangement comprises a port wing and a starboard wing, each mounted to a corresponding side of said fuselage.

235. The air vehicle according to any one of claims 201 to 233, wherein said wing arrangement comprises a integral wing having a port wing part and a starboard wing part, and wherein said wing is mounted to said fuselage via a pylon structure, such that the dorsal surface of the fuselage is facing the underside of the integral wing.

236. The air vehicle according to any one of claims 208 to 235, wherein in plan view or in bottom view at least a majority of each said sensor/emitter array is free from superposition by said wings.

237. The air vehicle according to any one of claims 204 to 236, wherein said fuselage comprises cross-sections at planes corresponding to locations of respective said sensor/emitter arrays, wherein a majority of each said cross-section is occupied by the respective said array.

238. The air vehicle according to any one of claims 204 to 237, wherein said fuselage has a profile that is generally determined by the size, shape and locations of said sensor/emitter arrays.

239. The air vehicle according to any one of claims 204 to 238, wherein said sensor/emitter arrays are arranged in said fuselage around an imaginary center point, wherein the sensor/emitter arrays are spaced from said center point by respective spacings which are dimensionally similar to one another.

240. The air vehicle according to claim 239, wherein at least some of said spacings are not equal to one another, and wherein a maximum said spacing is larger than a minimum said spacing by less than a factor of 2 times said minimum spacing.

241. An air vehicle, comprising:
a fuselage and a wing arrangement in fixed-wing configuration, said air vehicle having a longitudinal axis, and said fuselage having a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage;
the fuselage comprising a plurality of internal compartments peripherally disposed with respect thereto and configured for enabling integrating therein a sensor/emitter arrangement that is configured for at least one of sensing and emitting energy in directions associated with a plurality of different lines of sight (LOS) with respect to said fuselage;
said fuselage comprising a fuselage fineness ratio including at least one of:
a first fineness ratio, taken as a ratio of said fuselage length to said fuselage height, wherein said first fineness ratio is less than about 5;
a second fineness ratio, taken as a ratio of said fuselage length to said fuselage width, wherein said first fineness ratio is less than about 6;
an inverse oblateness ratio, taken as a ratio of said fuselage width to said fuselage height, wherein said inverse oblateness ratio is greater than 1.5.

242. The air vehicle according to claim 241, wherein said fuselage is configured for integrating said sensor/emitter arrangement therein for enabling optimizing operation of said sensor/emitter arrangement, wherein said sensor/emitter arrangement comprises at least one sensor/emitter array, the or each said sensor/emitter array comprising a sensing/emitting face that is elongated with respect to an elongation axis, and configured for enabling at least one said sensor/emitter array to be arranged with the respective sensing/emitting face thereof at least partially facing one of a forward direction and an aft direction along said longitudinal axis, and at least partially facing at least one side direction along said pitch axis.

243. The air vehicle according to claim 242, further comprising the sensor/emitter arrangement, wherein the sensor/emitter arrangement is configured for at least one of sensing and emitting energy in directions associated with a plurality of different lines of sight (LOS) with respect to said fuselage.

244. The air vehicle according to claim 243, wherein said sensor/emitter arrangement comprises at least one sensor/emitter array comprising a sensing/emitting face that is elongated with respect to an elongation axis, and wherein at least one said sensor/emitter array is arranged with the respective sensing/emitting face thereof at least partially facing one of a forward direction and an aft direction along said longitudinal axis, and at least partially facing at least one side direction along said pitch axis.

245. The air vehicle according to claim 244, wherein said elongation axis is generally aligned with an azimuthal plane of said air vehicle.

246. The air vehicle according to any one of claims 241 to 245, wherein the air vehicle is free of additional tail arrangement.

247. The air vehicle according to any one of claims 243 to 246, wherein said sensor/emitter arrangement comprises a plurality of said sensor/emitter arrays, each sensor/emitter array being configured for operating to provide sensor data or emit energy for a respective portion of a 360 degree azimuth volume with respect to the air vehicle referenced to at least one azimuthal reference plane.

248. The air vehicle according to any one of claims 243 to 247, wherein sensor/emitter arrangement may include one or more of: a radar jammer arrangement, a passive radar detector, a SIGINT module, an ELINT module, and a COMINT module, a guard antenna, IFF (identify friend or foe) elements, radio transmitting elements.

249. The air vehicle according to claim 247 or claim 248, wherein said sensor/emitter arrangement is configured for operating with respect to a substantially continuous 360 degree azimuth volume with respect to the air vehicle referenced to said azimuthal reference plane.

250. The air vehicle according to any one of claims 247 to 249, wherein said wing arrangement lacks any portions thereof that intersect with or that is below said azimuthal reference plane.

251. The air vehicle according to any one of claims 247 to 249, wherein at least one said sensor/emitter array is arranged with the respective sensing/emitting face thereof facing one of said forward and said aft direction

252. The air vehicle according to any one of claims 247 to 251, wherein at least one said sensor/emitter array is arranged with the respective elongation axis thereof substantially parallel to said pitch axis of the air vehicle, and located at an aft end of said fuselage.

253. The air vehicle according to claim 252, wherein said aft end comprises an aerodynamically blunt aft end.

254. The air vehicle according to any one of claims 252 to 253, wherein at least a majority of said aft end is closed and lacks a streamlined configuration.

255. The air vehicle according to any one of claims 252 to 254, wherein said aft end comprises a cross-section that is generally rounded in at least a majority of cross-sections taken perpendicular to the azimuthal reference plane and generally parallel to the longitudinal axis of the air vehicle.

256. The air vehicle according to any one of claims 247 to 255, wherein at least one said sensor/emitter array is arranged with the respective elongation axis thereof substantially inclined to said pitch axis and to said longitudinal axis, in plan view.

257. The air vehicle according to claim 256, wherein at least one said inclined elongation axis is inclined at an angle between about 10 degrees and about 80 degrees with respect to said longitudinal axis, in plan view.

258. The air vehicle according to claim 257, wherein at least one said inclined elongation axis is inclined at one of an angle of about 30 degrees with respect to said longitudinal axis and an angle of 60 degrees with respect to said longitudinal axis, in plan view.

259. The air vehicle according to any one of claims 247 to 258, comprising three said arrays, arranged with the respective elongate axes along the sides of an imaginary triangle.

260. The air vehicle according to claim 259, wherein said triangle is an isosceles triangle or an equilateral triangle.

261. The air vehicle according to any one of claims 247 to 260, comprising four or more said sensor/emitter arrays, arranged with their respective elongate axes in symmetrical disposition with respect to said longitudinal axis.

262. The air vehicle according to any one of claims 247 to 261, wherein each sensor/emitter array has an array height dimension and an array width dimension, taken orthogonal to and along with, respectively, the elongate direction, and an aspect ratio of array width to array height for at least one said array is between about 1.5 and about 10.

263. The air vehicle according to any one of claims 247 to 262, each said sensor/emitter array being further configured for operating with respect to elevation below said azimuthal reference plane, at least for a respective portion of a 360 degree azimuth volume, and wherein said sensor/emitter arrangement is configured for operating with respect to a hemispherical envelope centered on said fuselage and extending radially below said azimuthal reference plane.

264. The air vehicle according to any one of claims 247 to 263, each said sensor/emitter array being further configured for operating with respect to elevation above said azimuthal reference plane, at least for a respective portion of said 360 degree azimuth volume.

265. The air vehicle according to any one of claims 247 to 264, wherein said sensor/emitter arrays are configured for providing substantially similar sensor/emitter performance one to another, at least with respect to one of: sensor/emitter maximum range, sensor/emitter field of view in azimuth, sensor/emitter field of view in elevation with respect to said azimuthal reference plane.

266. The air vehicle according to any one of claims 247 to 265, wherein said sensor/emitter arrangement comprises a radar arrangement, and each said sensor/emitter array comprise a respective radar array for at least detecting a target.

267. The air vehicle according to claim 266, wherein said radar arrays comprise phase radar arrays.

268. The air vehicle according to any one of claims 241 to 267, wherein said air vehicle comprises a propulsion system dorsally mounted on said fuselage.

269. The air vehicle according to any one of claims 241 to 268 wherein said air vehicle is configured as a UAV or as a manned air vehicle, and wherein said air vehicle is configured as a subsonic or a transonic air vehicle.

270. The air vehicle according to any one of claims 247 to 269, wherein each said radar array is mounted in a respective said compartment in said fuselage and facing a fairing that forms part of the outer skin of the air vehicle.

271. The air vehicle according to claim 270, wherein at least one said sensor/emitter array is a radar array, and the respective fairing thereof is made from a material that is substantially transparent to the radar beams transmitted from and/or received by the respective radar array.

272. The air vehicle according to any one of claims 270 to 271, wherein said fairings each comprise a smooth rounded shape.

273. The air vehicle according to any one of claims 241 to 272, wherein said fuselage has an outer surface that is faceted, and wherein each said sensor/emitter array comprises a respective said fairing that is substantially flat and spaced from the respective sensor array, and which forms part of an external skin of said air vehicle.

274. The air vehicle according to any one of claims 241 to 273, wherein said wing arrangement comprises a port wing and a starboard wing, each mounted to a corresponding side of said fuselage.

275. The air vehicle according to any one of claims 241 to 274, wherein said wing arrangement comprises a integral wing having a port wing part and a starboard wing part, and wherein said wing is mounted to said fuselage via a pylon structure, such that the dorsal surface of the fuselage is facing the underside of the integral wing.

276. The air vehicle according to any one of claims 247 to 275, wherein in plan view or in bottom view at least a majority of each said sensor/emitter array is free from superposition by said wings.

277. The air vehicle according to any one of claims 247 to 276, wherein said fuselage comprises cross-sections at planes corresponding to locations of respective said sensor/emitter arrays, wherein a majority of each said cross-section is occupied by the respective said array.

278. The air vehicle according to any one of claims 247 to 277, wherein said fuselage has a profile that is generally determined by the size, shape and locations of said sensor/emitter arrays.

279. The air vehicle according to any one of claims 247 to 278, wherein said sensor/emitter arrays are arranged in said fuselage around an imaginary center point, wherein the sensor/emitter arrays are spaced from said center point by respective spacings which are dimensionally similar to one another.

280. The air vehicle according to claim 279, wherein at least some of said spacings are not equal to one another, and wherein a maximum said spacing is larger than a minimum said spacing by less than a factor of 2 times said minimum spacing.

281. A method for generating an air vehicle configuration, comprising:
(a) providing geometrical specifications of a plurality of sensors/emitters;
(b) providing desired relative spatial relationships between said sensors/emitters;
(c) providing a fairing configuration for each sensor/emitter, the respective fairing configuration being configured for minimizing interference with sensor/emitter operation of the respective sensor/emitter via the respective fairing;
(d) generating a fuselage configuration including an outer fuselage skin enclosing a fuselage volume, wherein said sensors/emitters are integrated within said fuselage volume in said desired relative spatial relationships, wherein said fairing configurations form part of said fuselage skin, and optimizing said fuselage configuration to provide optimal aerodynamic performance according to predetermined criteria, while substantially maintaining minimal interference of said fairing configuration with said sensor/emitter operation;
(e) providing a wing arrangement in fixed-wing relationship to said fuselage.

282. The method according to claim 281, wherein said air vehicle comprises a longitudinal axis, and wherein said fuselage comprises a fuselage length in a direction parallel to said longitudinal axis, a fuselage width in a direction parallel to a pitch axis of the air vehicle, and a fuselage height in a direction parallel to a yaw axis of the air vehicle, the air vehicle further defining at least one azimuthal reference plane that intersects said fuselage.

283. The method according to claim 282, wherein at least a part of said fuselage is formed having a generally oblate cross-section perpendicular to said longitudinal axis for accommodating therein at least some of said sensors/emitters.

284. The method according to any one of claim 281 or 282, wherein said fuselage is formed with an inverse oblateness ratio, taken as a ratio of said fuselage width to said fuselage height, greater than unity.

285. The method according to claim 284, wherein said inverse oblateness ratio is greater than about 1.5.

286. The method according to any one of claims 281 to 285, wherein said fuselage is formed with a first fineness ratio, taken as a ratio of said fuselage length to said fuselage width, of less than about 5.0, or less than about 2.0.

287. The method according to any one of claims 281 to 286, wherein each said sensor/emitter comprises a planar sensor/emitter array.

288. The method according to any one of claims 281 to 287, comprising configuring said air vehicle as a tailless air vehicle.

289. The method according to any one of claims 281 to 288, wherein said wing arrangement is configured to lack any portions thereof that intersect with or that is below an azimuthal reference plane with respect to the air vehicle.

290. The method according to any one of claims 282 to 289, wherein each said sensor/emitter array comprises a sensing/emitting face that is elongated with respect to an elongation axis.

291. The method according to claim 291, wherein said desired relative spatial relationships include arranging at least one said sensor/emitter array with the respective sensing/emitting face thereof at least partially facing one of a forward direction and an aft direction along said longitudinal axis, and at least partially facing at least one side direction along said pitch axis.

292. The method according to any one of claims 290 to 291, wherein said desired relative spatial relationships include arranging at least one said sensor/emitter array with the respective elongation axis thereof substantially parallel to said pitch axis of the air vehicle, and locating the respective array at an aft end of said fuselage.

293. The method according to claim 292, wherein said aft end is formed as an aerodynamically blunt aft end.

294. The method according to claim 292, wherein at least a majority of said aft end is closed and is formed lacking a streamlined configuration.

295. The method according to any one of claims 292 to 294, wherein said aft end is formed with a cross-section that is generally rounded in at least a majority of cross-sections taken perpendicular to the azimuthal reference plane and generally parallel to the longitudinal axis of the air vehicle.

296. The method according to any one of claims 287 to 295, wherein said desired relative spatial relationships include arranging at least one said sensor/emitter array with the respective elongation axis thereof substantially inclined to said pitch axis and to said longitudinal axis, in plan view.

297. The method according to claim 296, wherein at least one said inclined elongation axis is inclined at an angle between about 10 degrees and about 80 degrees with respect to said longitudinal axis, in plan view.

298. The method according to claim 295, wherein at least one said inclined elongation axis is inclined at one of an angle of about 30 degrees or an angle of 60 degrees with respect to said longitudinal axis, in plan view.

299. The method according to any one of claims 287 to 298, wherein three said sensor/emitter arrays are integrated in said fuselage volume, arranged with the respective elongate axes along the sides of an imaginary triangle.

300. The method according to claim 299, wherein said triangle is an equilateral triangle or an isosceles triangle.

301. The method according to any one of claims 287 to 298, wherein four or more said sensor/emitter arrays are integrated in said fuselage volume, arranged with their respective elongate axes in symmetrical disposition with respect to said longitudinal axis.

302. The method according to claim 301, wherein at least one said elongation axis is inclined at an angle of about 45 degrees with respect to said longitudinal axis.

303. The method according to any one of claims 287 to 302, wherein geometrical specifications comprise an array height dimension and an array width dimension for each sensor array, taken orthogonal to and along with, respectively, the elongate direction, and an aspect ratio of array width to array height for at least one said sensor/emitter array is between about 1.5 and about 10.

304. The method according to any one of claims 287 to 303, comprising positioning each said sensor/emitter array in said fuselage volume such to enable operation thereof in elevation below said azimuthal reference plane, at least for a respective portion of a 360 degree azimuth volume.

305. The method according to claim 304, wherein said sensors/emitters are arranged in said fuselage volume to enable operation thereof with respect to a hemispherical envelope centered on said fuselage and extending radially below said azimuthal reference plane.

306. The method according to any one of claims 287 to 305, each said sensor/emitter array being positioned in said fuselage volume such to enable operation thereof in elevation above said azimuthal reference plane, at least for a respective portion of said 360 degree azimuth volume.

307. The method according to claim 306, wherein said sensors/emitters are arranged in said fuselage volume to enable operation thereof with respect to elevation above said azimuthal reference plane, for said 360 degree azimuth volume excluding portions thereof associated with said wing arrangement.

308. The method according to any one of claims 287 to 307, wherein said sensor/emitter arrays are similarly dimensioned one to another.

309. The method according to any one of claims 287 to 308, further comprising dorsally mounting a propulsion system to said fuselage.

310. The method according to any one of claims 281 to 309, comprising configuring the air vehicle as a UAV.

311. The method according to any one of claims 281 to 309, comprising configuring the air vehicle as a manned air vehicle.

312. The method according to any one of claims 281 to 311, comprising configuring said air vehicle as a subsonic or a transonic air vehicle.

313. The method according to any one of claims 287 to 312, comprising forming said fuselage volume with a plurality of compartments, each said sensor/emitter array being comprised in a respective compartment in said fuselage and facing a respective said fairing.

314. The method according to claim 313, wherein at least one said fairing is made from a material that is substantially transparent to the radar beams transmitted from and/or received therethrough.

315. The method according to any one of claims 313 to 314, wherein said fairings are each formed comprising a smooth rounded shape.

316. The method according to any one of claims 281 to 314, wherein said fuselage skin is faceted, and wherein each said sensor/emitter array comprises a respective said fairing that is substantially flat and spaced from the respective sensor/emitter, and which forms part of said fuselage skin.

317. The method according to any one of claims 281 to 316, wherein said wing arrangement is formed as a port wing and a starboard wing, and mounting each wing to a corresponding side of said fuselage.

318. The method according to any one of claims 281 to 316, wherein said wing arrangement is formed as an integral wing having a port wing part and a starboard wing part, and comprising mounting the integral wing to said fuselage via a pylon structure, such that the dorsal surface of the fuselage is facing the underside of the integral wing.

319. The method according to any one of claims 287 to 318, wherein the sensor/emitter arrays and the wing arrangement are arranged with respect to the fuselage such that in plan view or in bottom view at least a majority of each said sensor/emitter array is free from superposition by said wings.

320. The method according to any one of claims 287 to 319, wherein said sensor/emitter arrays are radar arrays.

321. The method according to claim 320, wherein said radar arrays are phased arrays.

322. The method according to any one of claims 290 to 322, wherein said elongation axis is generally aligned with an azimuthal plane of said air vehicle.

323. The method according to any one of claims 280 to 322, wherein said fuselage is formed with cross-sections at planes corresponding to locations of respective said sensor/emitter arrays, wherein a majority of each said cross-section is occupied by the respective said array.

324. The method according to any one of claims 280 to 323, wherein said fuselage has a profile that is generally determined by the size, shape and locations of said sensor/emitter arrays.

325. The method according to any one of claims 280 to 324, wherein said sensor/emitter arrays are arranged in said fuselage around an imaginary center point, wherein the sensor/emitter arrays are spaced from said center point by respective spacings which are dimensionally similar to one another.

326. The method according to claim 325, wherein at least some of said spacings are not equal to one another, and wherein a maximum said spacing is larger than a minimum said spacing by less than a factor of 2 times said minimum spacing.
